(19) United States
(12) Patent Application Publication
(10) Pub. No.: US 2005/0053905 A1
(43) Pub. Date: Mar. 10, 2005

(54) Interactive training, certification and development system

(76) Inventor: Stephen Sadler, Clarkston, MI (US)

Correspondence Address: Warn, Hoffmann, Miller & LaLone, P.C., P.O. Box 70098, Rochester Hills, MI, 48307, US

(21) Appl. No.: 10/897,199

(22) Filed: Jul. 22, 2004

Related U.S. Application Data
(60) Provisional application No. 60/489,624, filed on Jul. 24, 2003.

(51) Int. Cl. G09B 5/00; G09B 19/00

(52) U.S. Cl. 434/309; 434/323

(57) ABSTRACT

Training, certification, courseware development systems are described that allow an individual (e.g., a student, trainee or the like) to learn and/or become certified on a topic (e.g., a software application) by using simulation of the actual software application. The systems provide the student or trainee with an interactive experience that enhances the educational experience through a combination of various multimedia technologies.

### CROSS-REFERENCE TO RELATED APPLICATION

The instant application claims priority to U.S. Provisional Patent Application Ser. No. 60/489,624, filed Jul. 24, 2003, the entire specification of which is expressly incorporated herein by reference.

### FIELD OF THE INVENTION

This invention relates generally to training systems, more particularly training systems for various topics including software applications, and still more particularly to Internet-based computer software application training and certification systems that simulate the actual software application being trained and/or certified on without using and/or purchasing the actual software.

### BACKGROUND OF THE INVENTION

The use of training programs for instruction and/or certification on particular topics, including various computer software applications, has become increasingly common. With the advent of the Internet, there has been recent interest in providing Internet-based (e.g., World Wide Web) programs that can satisfy these training needs.

With respect to the understanding of these topics, especially medical, technical and software applications, it has become increasingly problematic to use the actual software application itself, as copies of the software application itself (or a license therefor) may be very expensive to purchase and may entail undesired contractual obligations and/or legal liabilities. Additionally, some software applications do not contain sufficient tutorial and/or instructional content, and thus may lead to a sub-optimal learning experience. Further, some individuals may wish to sample and learn the software applications to determine their usefulness without having to purchase them beforehand.

Accordingly, there exists a need for training and/or certification systems that allow an individual (e.g., student, trainee or the like) to learn any topic, especially those that are technically-oriented, including but not limited to software applications, and/or become certified thereon by using a simulation of the actual application, including the software application.

### SUMMARY OF THE INVENTION

In accordance with the general teachings of the present invention, training and/or certification systems are provided that simulates the actual topic being trained and/or certified on. The present invention can be used with any topic, including those that are technically-oriented, and is especially suitable for use with software applications. The present invention can be Internet-based, for example through the World Wide Web, so that students or trainees may access these systems remotely from various locations (e.g., work, home, while traveling, and the like) and at convenient times according to their schedules (e.g., weeknights, weekends, holidays, and the like).

In accordance with one aspect of the present invention, the systems of the present invention can be administered to a student or trainee, for example over the Internet, in order to educate, train or otherwise instruct the student or trainee on various applications in order to ensure that they are comfortable working with the topic and have demonstrated a certain level of proficiency with the topic. The systems of the present invention can also provide quizzes, tests, exams or the like to ensure that the student or trainee has properly absorbed the lessons associated with the topic instruction.

In accordance with another aspect of the present invention, the systems of the present invention can be administered to a student or trainee, for example over the Internet, in order to certify to a third party (e.g., the Society of Automotive Engineers) that the student or trainee has demonstrated a pre-determined level of competency with respect to the understanding and/or use of the topic, for example, through a timed examination consisting of randomized questions that are graded.

The present invention preferably provides the student or trainee with a computerized software training environment/interface that simulates the actual topic or software application being trained on. The present invention can preferably provide a software training environment that can simulate any topic or software application. Also, the training/certification system of the present invention can be viewed via the Internet or locally on a student or trainee's computer or workstation, and is a compliment with any operating system, such as but not limited to Unix, Linux, Windows, Mac, or the like.

The design and process of the present invention preferably includes several features, including without limitation: full virtual training without any licenses; full interactivity of menus, commands and functionality; high speed training via the Internet; four (e.g., lecture, interactive, quiz, final examination/certification) phase training techniques; simulation techniques; and advanced help systems.

The present invention preferably provides full interactivity through FLASH-based (or other functionally similar programs such as SHOCKWAVE, JAVA, HTML, or the like) action algorithms used to simulate menus, commands, functionality, and the like. High-speed training performance is preferably provided and attributed to simulation techniques also developed in FLASH (or other functionally similar programs such as SHOCKWAVE, JAVA, HTML, or the like). The present invention preferably allows a student or trainee to experience the same look and feel that the student or trainee would experience if he/she had the actual software application loaded directly onto their computer or workstation, or had exposure to a technical topic, such as engineering processes. Thus, the present invention preferably provides full interactivity of menus, commands and functionality of the training environment as compared to the actual topic or software application.

Further, the performance and speed of training in conjunction with the present invention is preferably enhanced as a result of the simulation techniques employed. Thus, the present invention preferably addresses the problem of non-interactive and slow Internet-based training currently available in the art. Accordingly, the present invention preferably provides an increased level and efficiency of online and CD-based training, and a decrease in associated training, courseware development, and time costs.

In accordance with a first embodiment of the present invention, a computerized guided training program is provided, comprising: (1) a source of subject matter; (2) a subject matter delivery system operable to deliver the subject matter to a user; and (3) an interactive training system in operable association with the delivery system, wherein the interactive training system comprises multiple modes of subject matter presentation, wherein the modes are selectively chosen from the group consisting of lectures, exercises, examinations, and combinations thereof.

In accordance with a second embodiment of the present invention, a computerized guided training program is provided, comprising: (1) a source of subject matter, wherein the source of subject matter comprises data selected from the group consisting of video files, audio files, animation files, database files, graphics files, text files, tabular files, and combinations thereof; (2) a subject matter delivery system operable to deliver the subject matter to a user; and (3) an interactive training system in operable association with the delivery system, wherein the interactive training system comprises multiple modes of subject matter presentation, wherein the modes are selectively chosen from the group consisting of lectures, exercises, examinations, and combinations thereof, wherein the interactive training system includes a user status information system.

In accordance with a third embodiment of the present invention, a computerized guided training program is provided, comprising: (1) a source of subject matter, wherein the source of subject matter comprises data selected from the group consisting of video files, audio files, animation files, database files, graphics files, text files, tabular files, and combinations thereof; (2) a subject matter delivery system operable to deliver the subject matter to a user; and (3) an interactive training system in operable association with the delivery system, wherein the interactive training system comprises multiple modes of subject matter presentation, wherein the modes are selectively chosen from the group consisting of lectures, exercises, examinations, and combinations thereof, wherein the interactive training system includes a user status information system, wherein the user status information system is operable to provide information about the user selected from the group consisting of account information, demographic information, financial information, academic information, and combinations thereof.

In accordance with a fourth embodiment of the present invention, a computerized guided certification program is provided, comprising: (1) a source of subject matter; (2) a subject matter delivery system operable to deliver the subject matter to a user; and (3) an interactive certification system in operable association with the delivery system, wherein the interactive certification system comprises multiple modes of subject matter presentation.

In accordance with a fifth embodiment of the present invention, a computerized guided certification program is provided, comprising: (1) a source of subject matter; (2) a subject matter delivery system operable to deliver the subject matter to a user; and (3) an interactive certification system in operable association with the delivery system, wherein the interactive certification system comprises multiple modes of subject matter presentation, wherein the interactive certification system includes a randomization system for randomizing the presentation of the subject matter.

In accordance with a sixth embodiment of the present invention, a computerized guided certification program is provided, comprising: (1) a source of subject matter; (2) a subject matter delivery system operable to deliver the subject matter to a user; and (3) an interactive certification system in operable association with the delivery system, wherein the interactive certification system comprises multiple modes of subject matter presentation, wherein the interactive certification system includes a randomization system for randomizing the presentation of the subject matter, wherein the interactive certification system includes a certification authorization system.

In accordance with a seventh embodiment of the present invention, a courseware development system for a computerized guided training or certification system is provided, comprising: (1) a subject matter delivery system operable to deliver a source of subject matter to a user; and (2) a subject matter management system in operable association with the delivery system, wherein the subject matter management system is operable to dynamically create, delete, or modify subject matter.

In accordance with an eighth embodiment of the present invention, a courseware development system for a computerized guided training or certification system is provided, comprising: (1) a subject matter delivery system operable to deliver a source of subject matter to a user; and (2) a subject matter management system in operable association with the delivery system, wherein the subject matter management system is operable to dynamically create, delete, or modify subject matter, wherein the subject matter management system is operable to modify multiple modes of subject matter presentation.

In accordance with a ninth embodiment of the present invention, a courseware development system for a computerized guided training or certification system is provided, comprising: (1) a subject matter delivery system operable to deliver a source of subject matter to a user; and (2) a subject matter management system in operable association with the delivery system, wherein the subject matter management system is operable to dynamically create, delete, or modify subject matter, wherein the subject matter management system is operable to modify multiple modes of subject matter presentation, wherein the subject matter management system includes a user access control system.

Additional advantages and features of the present invention will become apparent from the following description and appended claims, taken in conjunction with the accompanying drawings.

### BRIEF DESCRIPTION OF THE DRAWINGS

The present invention will become more fully understood from the detailed description and the accompanying drawings, wherein:

FIG. 1 is a schematic illustration of a flowchart illustrating the primary processing steps of a training system, in accordance with a first embodiment of the present invention;

FIG. 2 is a schematic illustration of a flowchart illustrating the primary processing steps of a certification system, in accordance with a second embodiment of the present invention;

FIG. 3 is a schematic illustration of a flowchart illustrating the primary processing steps of a training/certification development courseware system, in accordance with a third embodiment of the present invention;

FIG. 4 is a view of a screen capture illustrating a main interface screen of a training/certification system, in accordance with a fourth embodiment of the present invention;

FIG. 5 is a view of a screen capture illustrating a catalog interface screen of a training/certification system, in accordance with a fourth embodiment of the present invention;

FIG. 6 is a view of a screen capture illustrating an e-commerce interface screen of a training/certification system, in accordance with a fourth embodiment of the present invention;

FIG. 7 is a view of a screen capture illustrating a user login interface screen of a training/certification system, in accordance with a fourth embodiment of the present invention;

FIG. 8 is a view of a screen capture illustrating a main user interface screen of a training/certification system, in accordance with a fourth embodiment of the present invention;

FIG. 9 is a view of a screen capture illustrating a student notes management interface screen of a training/certification system, in accordance with a fourth embodiment of the present invention;

FIG. 10 is a view of a screen capture illustrating a student administration interface screen of a training/certification system, in accordance with a fourth embodiment of the present invention;

FIG. 11 is a view of a screen capture illustrating a course outline interface screen of a training system, in accordance with a fifth embodiment of the present invention;

FIG. 12 is a view of a screen capture illustrating a course table of contents interface screen of a training system, in accordance with a fifth embodiment of the present invention;

FIG. 13 is a view of a screen capture illustrating a lecture mode transition interface screen of a training system, in accordance with a fifth embodiment of the present invention;

FIG. 14 is a view of a screen capture illustrating a lecture mode display interface (software training) screen of a training system, in accordance with a fifth embodiment of the present invention;

FIG. 15 is a view of a screen capture illustrating a lecture mode display interface (general training) screen of a training system, in accordance with a fifth embodiment of the present invention;

FIG. 16 is a view of a screen capture illustrating a lecture completion interface (software training) screen of a training system, in accordance with a fifth embodiment of the present invention;

FIG. 17 is a view of a screen capture illustrating an interactive mode transition interface screen of a training system, in accordance with a fifth embodiment of the present invention;

FIG. 18 is a view of a screen capture illustrating an interactive mode display interface (software training) screen of a training system, in accordance with a fifth embodiment of the present invention;

FIG. 19 is a view of a screen capture illustrating an interactive mode display interface (general training) screen of a training system, in accordance with a fifth embodiment of the present invention;

FIG. 20 is a view of a screen capture illustrating an interactive completion interface (software training) screen of a training system, in accordance with a fifth embodiment of the present invention;

FIG. 21 is a view of a screen capture illustrating a quiz mode transition interface screen of a training system, in accordance with a fifth embodiment of the present invention;

FIG. 22 is a view of a screen capture illustrating a quiz mode display interface (software training) screen of a training system, in accordance with a fifth embodiment of the present invention;

FIG. 23 is a view of a screen capture illustrating a quiz evaluation display interface (software training) screen of a training system, in accordance with a fifth embodiment of the present invention;

FIG. 24 is a view of a screen capture illustrating a student profile interface (software training) screen of a training system, in accordance with a fifth embodiment of the present invention;

FIG. 25 is a view of a screen capture illustrating a notes manager listing interface screen of a training system, in accordance with a fifth embodiment of the present invention;

FIG. 26 is a view of a screen capture illustrating a new note creation interface screen of a training system, in accordance with a fifth embodiment of the present invention;

FIG. 27 is a view of a screen capture illustrating a note search interface screen of a training system, in accordance with a fifth embodiment of the present invention;

FIG. 28 is a view of a screen capture illustrating a chat, forum, and email support screen of a training system, in accordance with a fifth embodiment of the present invention;

FIG. 29 is a view of a screen capture illustrating a certification outline interface screen of a certification system, in accordance with a sixth embodiment of the present invention;

FIG. 30 is a view of a screen capture illustrating a certification login interface (proctor enabled) screen of a certification system, in accordance with a sixth embodiment of the present invention;

FIG. 31 is a view of a screen capture illustrating a main user certification interface screen of a certification system, in accordance with a sixth embodiment of the present invention;

FIG. 32 is a view of a screen capture illustrating a main administration certification interface screen of a certification system, in accordance with a sixth embodiment of the present invention;

FIG. 33 is a view of a screen capture illustrating a data mining, certification editing and creation interface screen of a certification system, in accordance with a sixth embodiment of the present invention;

FIG. 34 is a view of a screen capture illustrating an adding/deleting courses, lessons, exercises and user access interface screen of a courseware development system for a training/certification system, in accordance with a seventh embodiment of the present invention;

FIG. 35 is a view of a screen capture illustrating an adding course parameters interface screen of a courseware development system for a training/certification system, in accordance with a seventh embodiment of the present invention;

FIG. 36 is a view of a screen capture illustrating an adding lesson parameters interface screen of a courseware development system for a training/certification system, in accordance with a seventh embodiment of the present invention;

FIG. 37 is a view of a screen capture illustrating an adding exercise parameters interface screen of a courseware development system for a training/certification system, in accordance with a seventh embodiment of the present invention;

FIG. 38 is a view of a screen capture illustrating an adding/editing content exercise interface screen of a courseware development system for a training/certification system, in accordance with a seventh embodiment of the present invention;

FIG. 39 is a view of a screen capture illustrating an adding/editing lecture content interface screen of a courseware development system for a training/certification system, in accordance with a seventh embodiment of the present invention;

FIG. 40 is a view of a screen capture illustrating an adding/editing interactive content interface screen of a courseware development system for a training/certification system, in accordance with a seventh embodiment of the present invention;

FIG. 41 is a view of a screen capture illustrating an adding/editing quiz questions interface screen of a courseware development system for a training/certification system, in accordance with a seventh embodiment of the present invention;

FIG. 42 is a view of a screen capture illustrating a sound and video interface screen of a courseware development system for a training/certification system, in accordance with a seventh embodiment of the present invention; and

FIG. 43 is a view of a screen capture illustrating an field mapping interface screen of a courseware development system for a training/certification system, in accordance with a seventh embodiment of the present invention.

### DETAILED DESCRIPTION OF THE EMBODIMENTS

The following description of the preferred embodiment(s) is merely exemplary in nature and is in no way intended to limit the invention, its applications, or uses.

In accordance with a preferred embodiment of the present invention, a computerized guided training program is provided, comprising: (1) a source of subject matter; (2) a subject matter delivery system operable to deliver the subject matter to a user; and (3) an interactive training system in operable association with the delivery system, wherein the interactive training system comprises multiple modes of subject matter presentation, wherein the modes are selectively chosen from the group consisting of lectures, exercises, examinations, and combinations thereof.

The source of the subject matter can include, without limitation, databases, electronic databases, data containment systems, and data selected from the group consisting of video files, audio files, animation files, database files, graphics files, text files, tabular files, and combinations thereof.

The subject matter delivery system can include, without limitation, computer servers, computer networks, data storage devices, optical mediums (CD, DVD, or the like), transmissions of the subject matter across a wide area network, transmissions of the subject matter across a local area network, transmissions of the subject matter from one data storage device to a second data storage device, and wireless transmissions of the subject matter.

The presentation of multiple modes of subject matter presentation can include, without limitation, text, video, audio, graphics, animation, and combinations thereof.

Furthermore, the interactive training system preferably includes a user status information system, wherein the user status information system is operable to provide information about the user that can include, without limitation, account information, demographic information, financial information, academic information, and combinations thereof.

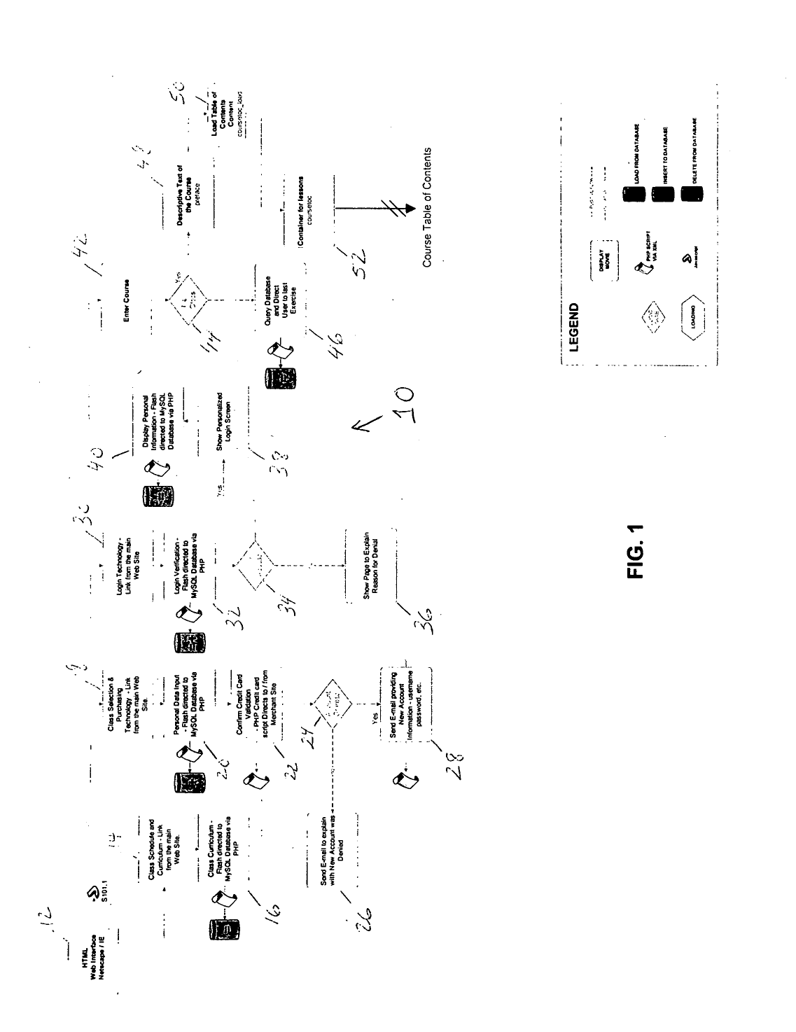

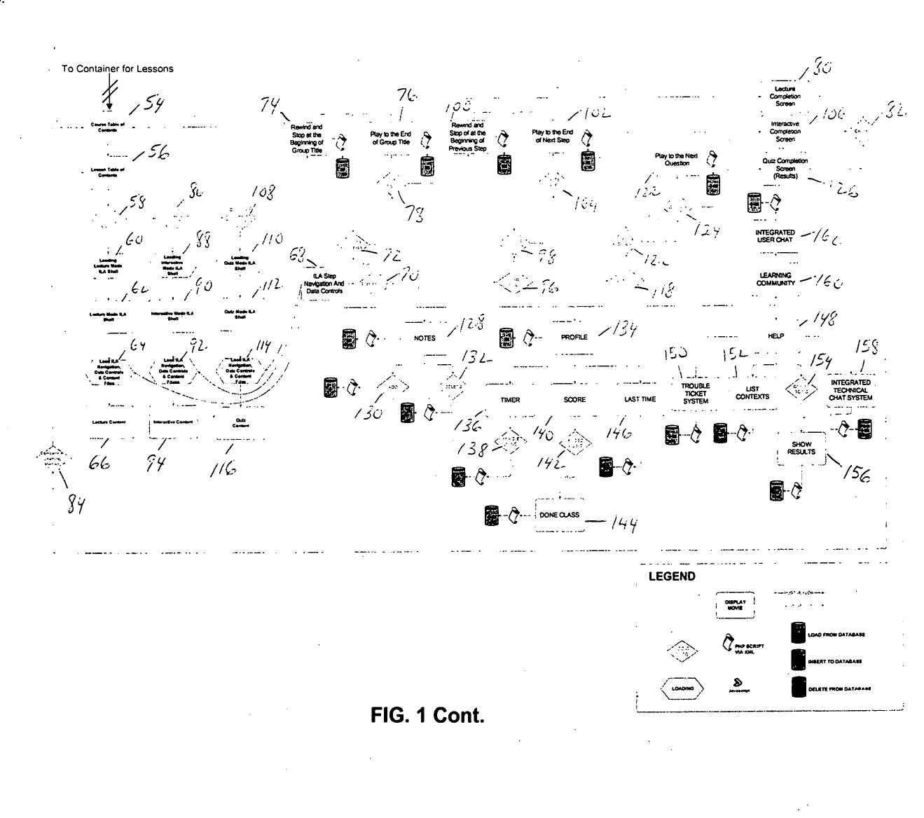

Referring to FIG. 1, there is generally shown a schematic view of a flowchart illustrating the primary processing steps of a preferably interactive and guided training system, in accordance with a first embodiment of the present invention. The training system of the present invention can be practiced in conjunction with the Internet, World Wide Web, intranets, extranets, electronic media (e.g., CD/DVD-based systems), or the like. By “training,” as that term is used herein, it is meant any educational, instructional and/or learning system. The subject matter that can be trained on is not limited, as it may include any topic including the physical, chemical and/or biological sciences, any type of engineering, including aeronautical, automotive, chemical, civil, computer, electrical, industrial, nuclear, or the like, as well as any other topic, including non-scientific topics. Although the training system of the present invention will refer generally to training and/or certification on software program(s) that have primary application to automotive engineering, it should be appreciated that this is for illustrative purposes only.

In order to fully appreciate the benefits and features of the training system of the present invention, it is assumed that an individual practicing the present invention will preferably have: access to a computer (and is conversant with the basic functions thereof); an Internet service provider (“ISP”) (e.g., AOL, JUNO, or the like) with e-mail capability; a Web browser (e.g., INTERNET EXPLORER, NETSCAPE, or the like); any required plug-ins (e.g., FLASH, SHOCKWAVE, JAVA VIRTUAL MACHINE, or the like); and have the ability to navigate successfully to any given uniform resource locator (“URL”).

Preferably, the first step is for the individual to successfully navigate to the URL of the main Web Site that contains the training system 10 of the present invention (e.g., with the aid of a Web browser, such as INTERNET EXPLORER, NETSCAPE, or the like). By way of a non-limiting example, the URL http://www.scate.com has been designated as the main Web Site for the training system 10 of the present invention. Once this URL is accessed, it will cause a graphical movie screen 12 (e.g., FLASH, SHOCKWAVE, JAVA, HTML or the like) to be displayed as a result of a action within the HyperText Markup Language (“HTML”) Web interface file (e.g., written with the aid of a programming language, such as but not limited to JavaScript), thus letting the individual know that he has arrived at the correct training system Web Site.

It should be appreciated that the student or trainee will occasionally be required to click on various links in order to navigate to various portions of the Web Site.

The next step is a graphical movie screen 14 that displays, e.g., a class schedule and curriculum, which is preferably linked from the main Web Site. The class schedule and curriculum will be dependent, in part, on the number and types of courses that are provided by the training system 10.

The next step is a graphical movie screen 16 that displays, e.g., a class curriculum, course description and costs, which is preferably client-directed to a database, such as but not limited to MySQL or SQL Database (e.g., an open source relational database management system) through a server access database script such as but not limited to PHP script (e.g., a hypertext preprocessor) or ASP (e.g., active server pages) via a data packaging code such as but not limited to XML (e.g., Extensible Markup Language). That is, the class curriculum and other information are preferably loaded from the database containing that information.

The next step is preferably for a graphical movie screen 18 that displays, e.g., a class selection and/or purchasing technology, which is preferably linked from the main Web Site.

The next step is for a graphical movie screen 20 that displays, e.g., a request for personal data input, which is preferably client-directed to the database through a server database connection script. That is, the individual's personal data, once input, is loaded to the database designated to receive and store that information.

The next step is for a graphical movie screen 22 that displays, e.g., a confirmation of the credit card validation, wherein a credit card script directs to or from the merchant site through a database connection script via data packaging code. That is, the individual's credit card information is validated so that they can purchase a particular course and/or open a new account.

At this point, a logic gate 24 is preferably reached wherein a decision is made whether to open a new account or admit the individual into the course, e.g., if the credit card has been approved, or not to open a new account so as to admit the individual into the course, e.g., if the credit card was declined or if incorrect information was entered.

If a request for a new account or admission was declined, a graphical movie 26 is preferably displayed that will alert the individual that an e-mail was sent to explain the reason(s) for denial of admission.

If a request for a new account or admission was approved, a graphical movie 28 is preferably displayed that will alert the individual that an e-mail was sent to provide information about the new account such as but not limited to a username, password, and the like, through a server database connection script via data packaging code.

The next step is for a graphical movie screen 30 that displays, e.g., login technology, which is preferably linked from the main Web Site. That is, a login information request page is displayed, so that the individual can log in with his/her username and password, for example.

The next step is for a graphical movie screen 32 that displays, e.g., a login verification, which is preferably client-directed to the database through a server database connection script via data packaging code. That is, the login verification is loaded from and/or loaded to the database designated to send, receive and/or store that information.

At this point, a logic gate 34 is preferably reached wherein a decision is made whether to allow the individual access to the course, e.g., if the login verification has occurred without incident, or not to allow the individual access to the course, e.g., if the login verification did not occur properly.

If access was not approved, a graphical movie 36 is preferably displayed that will alert the individual that access was denied along with a reason or reasons for the disapproval.

If access was approved, a graphical movie 38 is preferably displayed that will show the individual's personalized login screen.

The next step is for a graphical movie screen 40 that displays, e.g., a display of the individual's personal information, which is preferably client-directed to the database through the server database connection script via data packaging code. That is, the individual's personal information is loaded from the database designated to send and/or store that information.

The next step is for a graphical movie screen 42 that displays, e.g., an enter course screen. At this point, a logic gate 44 is preferably reached wherein a decision is made whether this individual has previously accessed this course.

If the individual has previously accessed the course, a graphical movie 46 is preferably displayed, e.g., that will query the database and direct the individual to the table of contents where it will display the last point accessed in the course (e.g., bookmarking), which is preferably loaded from the database through the server database connection script via data packaging code.

If the individual has not previously accessed the course, a graphical movie 48 is preferably displayed, e.g., that will show the descriptive text of the course, e.g., a preface.

At this point, a loading point 50 is preferably reached wherein the table of contents content is loaded from a server, which preferably can be delivered by the provider of the training system 10.

The next step is for a graphical movie screen 52 that displays, e.g., a container for the lessons to be loaded.

The next step is for a graphical movie screen 54 that displays, e.g., a course table of contents.

The next step is for a graphical movie screen 56 that displays, e.g., a lesson table of contents. At this point, a preferably specific sequence of training modes is introduced, consisting of a lecture mode, an interactive mode, and a quiz mode. It should be appreciated that the sequence can be varied depending on the particular needs of the client and/or student/trainee.

At this point, a logic gate 58 is preferably reached wherein a decision is made whether or not the student or trainee has completed the lecture learning method, e.g., if the lecture mode module has or has not been completed by the student or trainee.

If the lecture learning method was not completed, a loading point 60 is preferably reached wherein the lecture mode interactive learning agent (“ILA”) shell is loaded from a server, which preferably can be delivered by the provider of the training system 10. The phrase “interactive learning agent,” as that term is used herein, is meant to include any system, method, technique that allows the student or trainee to interact, either directly or indirectly, with the training system 10 and/or associated data containment systems, databases, subject matter, or the like.

The next step is for a graphical movie screen 62 that displays, e.g., a lecture mode ILA shell.

At this point, a loading point 64 is preferably reached wherein ILA navigation, data controls and content files are loaded from a server, which preferably can be delivered by the provider of the training system 10.

The next step is for a graphical movie screen 66 that displays, e.g., a lecture content.

The student or trainee can then use the ILA step navigation and data controls system, which is preferably linked to the lecture content loading shell, interactive content loading shell, and/or the quiz content loading shell. The ILA step navigation and data controls system allows the student or trainee the option of exploring various other portions of the training system 10, as will be described in detail herein.

Thus, the next step is for a graphical movie screen 68 that displays, e.g., an ILA step and navigation data controls. At this point, the student or trainee has several options as to which action to carry out next.

By way of a non-limiting example, a logic gate 70 is preferably reached wherein a decision is made whether or not to review the lecture mode materials. If the decision is made to review the lecture mode materials, a logic gate 72 is preferably reached wherein the option of navigation direction (i.e., forward, fast forward, backward, fast backward, or the like) is given to the student or trainee.

If the decision is made to go backward, a graphical movie screen 74 is displayed that allows the student or trainee to rewind the lecture content and stop at the beginning of a group title, for example, which is preferably loaded from the database through the server database connection script via data packaging code.

If the decision is made to go forward, a graphical movie screen 76 is displayed that allows the student or trainee to play to the end of the group title, for example, which is preferably loaded from the database through the server database connection script via data packaging code.

At this point, a logic gate 78 is preferably reached wherein a decision is made whether or not the lecture mode has run to its completion point. If it has, a graphical movie screen 80 is displayed that indicates that the lecture mode has been completed.

Once the review of the lecture training mode has been completed, a logic gate 82 is preferably reached wherein a decision is made whether to continue from that point on. If so, a logic gate 84 is preferably reached wherein a decision is made as to whether all of the learning methods have been completed. If not, the graphical movie screen 56 is displayed, e.g., the lesson table of contents. If so, the graphical movie screen 54 is displayed, e.g., the course table of contents.

If the individual has completed the lecture mode, the individual will navigate through the lesson table of contents screen, wherein logic gate 58 is preferably reached wherein a decision is made whether the lecture mode was completed or not.

If the lecture learning method was completed, a logic gate 86 is preferably reached wherein a decision is made whether or not the student or trainee has completed the interactive learning method, e.g., if the interactive mode module has or has not been completed by the student or trainee. If not, a loading point 88 is preferably reached wherein the interactive ILA mode shell is loaded from a server, which preferably can be delivered by the provider of the training system 10.

The next step is for a graphical movie screen 90 that displays, e.g., an interactive mode ILA shell.

At this point, a loading point 92 is preferably reached wherein the ILA navigation, data controls and content files are loaded from a server, which preferably can be delivered by the provider of the training system 10.

The next step is for a graphical movie screen 94 that displays, e.g., an interactive content.

The student or trainee can then use the ILA step navigation and data controls system, which is preferably linked to the lecture content loading shell, interactive content loading shell, and/or the quiz content loading shell. The ILA step navigation and data controls system allows the student or trainee the option of exploring various other portions of the training system 10, as will be described in detail herein.

By way of a non-limiting example, a logic gate 96 (after proceeding through the previous lecture logic gate 70 described herein) is preferably reached wherein a decision is made whether or not to review the interactive mode materials. If the decision is made to review the interactive mode materials, a logic gate 98 is preferably reached wherein the option of navigation direction (i.e., forward or backward) is given to the student or trainee.

If the decision is made to go backward, a graphical movie screen 100 is displayed that allows the student or trainee to rewind and stop at the beginning of a previous step, for example, which is preferably loaded from the database through the server database connection script via data packaging code.

If the decision is made to go forward, a graphical movie screen 102 is displayed that allows the student or trainee to play to the end of the next step, for example, which is preferably loaded from the database through the server database connection script via data packaging code.

At this point, a logic gate 104 is preferably reached wherein a decision is made whether or not the interactive mode has run to its completion point. If it has, a graphical movie screen 106 is displayed that indicates that the interactive mode has been completed.

Once the review of the interactive training mode has been completed, logic gate 82 is preferably reached wherein a decision is made whether to continue from that point on. If so, logic gate 84 is preferably reached wherein a decision is made at to whether all of the learning methods have been completed. If not, the graphical movie screen 56 is displayed, e.g., the lesson table of contents. If so, the graphical movie screen 54 is displayed, e.g., the course table of contents.

If the individual has completed the interactive mode, the individual will navigate through the lesson table of contents screen, wherein logic gate 86 (after proceeding through the previous lecture logic gate 58 described herein) is preferably reached wherein a decision is made whether the interactive mode was completed or not.

If the interactive learning method was completed, a logic gate 108 is preferably reached wherein a decision is made whether or not the student or trainee has completed the interactive learning method, e.g., if the interactive mode module has or has not been completed by the student or trainee. If not, a loading point 110 is preferably reached wherein the quiz mode ILA shell is loaded from a server, which preferably can be delivered by the provider of the training system 10.

The next step is for a graphical movie screen 112 that displays, e.g., a quiz mode ILA shell.

At this point, a loading point 114 is preferably reached wherein the ILA navigation, data controls and content files are loaded from a server, which preferably can be delivered by the provider of the training system 10.

The next step is for a graphical movie screen 116 that displays, e.g., a quiz content.

The student or trainee can then use the ILA step navigation and data controls system, which is preferably linked to the lecture content loading shell, interactive content loading shell, and/or the quiz content loading shell. The ILA step navigation and data controls system allows the student or trainee the option of exploring various other portions of the training system 10, as will be described in detail herein.

By way of a non-limiting example, a logic gate 118 is preferably reached wherein a decision is made whether or not to review the quiz mode materials. If the decision is made to review the quiz mode materials, a logic gate 120 is preferably reached wherein the option of navigation direction is given to the student or trainee.

If the decision is made to review the questions of the quiz mode, a graphical movie screen 122 is displayed that allows the student or trainee to view any particular question, for example, which is preferably loaded from the database through the server database connection script via data packaging code.

At this point, logic gate 124 is preferably reached wherein a decision is made whether or not the quiz mode has run to its completion point (e.g., every question has been reviewed and/or answered). If it has, a graphical movie screen 126 is displayed that indicates that the quiz mode has been completed.

Once the review of the quiz training mode has been completed, logic gate 82 is preferably reached wherein a decision is made whether to continue from that point on. If so, logic gate 84 is preferably reached wherein a decision is made at to whether all of the learning methods have been completed. If not, the graphical movie screen 56 is displayed, e.g., the lesson table of contents. If so, the graphical movie screen 54 is displayed, e.g., the course table of contents.

Once, all three training modes have been completed, logic gate 108 (after proceeding through the previous lecture logic gate 58 and interactive logic gate 86 described herein) is preferably reached wherein a decision is made whether the quiz learning method has been completed or not. If this is answered in the affirmative, the graphical movie screen 54 is displayed, e.g., the course table of contents.

Alternatively, the student or trainee can also use the ILA step navigation and data controls system to navigate to different parts of the training system 10 that do not necessary concern the specifics of the lecture, interactive, and/or quiz learning modes. For example, the training system 10 can also include various optional and auxiliary features and functions that enhance the learning process for the student or trainee. By way of a non-limiting example, features such as a notes section, profile section, help section, and learning community section, are provided for.

If the student or trainee navigates to the notes section, a graphical movie screen 128 is displayed that allows the student or trainee to view any particular note they have created, for example, which is preferably loaded from the database through the server database connection script via data packaging code. At this point, the student or trainee is given the option of either adding, modifying, printing, searching and/or deleting notes.

If the student wishes to add notes, a logic gate 130 is preferably reached wherein a decision is made to add notes, whereupon the student inputs the notes, which are preferably loaded to the database through the server database connection script via data packaging code.

If the student wishes to delete notes, a logic gate 132 is preferably reached wherein a decision is made to delete notes, whereupon the student deletes the notes, which are preferably deleted from the database through the server database connection script via data packaging code.

If the student or trainee navigates to the profile section, a graphical movie screen 134 is displayed that allows the student or trainee to view his/her particular profile that has created on their behalf, for example, which is preferably loaded from the database through the server database connection script via data packaging code. At this point, the student or trainee is given the option of exploring the timer section, score section, or last time section of the profile section.

If the student or trainee navigates to the timer section, a graphical movie screen 136 is displayed that allows the student or trainee to view any particular exercise they have accessed, for example. At this point, a logic gate 138 is preferably reached wherein a decision is made whether the exercise has been completed, and if this is answered in the affirmative, this information is preferably loaded to the database through the server database connection script via data packaging code.

If the student or trainee navigates to the score section, a graphical movie screen 140 is displayed that allows the student or trainee to view the scores they have received, for example. At this point, a logic gate 142 is preferably reached wherein a decision is made whether the course has been completed so as to give the student or trainee an overall average, and if this is answered in the affirmative, a graphical movie screen 144 is displayed that informs the student or trainee that the course is completed (e.g., via e-mail), which is preferably loaded to and/or from the database through the server database connection script via data packaging code.

If the student or trainee navigates to the last time section, a graphical movie screen 146 is displayed that allows the student or trainee to view when the last time they accessed a course was, for example, which is preferably loaded from the database through the server database connection script via data packaging code.

If the student or trainee navigates to the help section, a graphical movie screen 148 is displayed that allows the student or trainee to view various help topics. At this point, the student or trainee is given the option of exploring the trouble ticket system section, list contexts section, or integrated technical chat system (e.g., chat and/or forums sections).

If the student or trainee navigates to the trouble ticket system section, a graphical movie screen 150 is displayed that allows the student or trainee to input a trouble message about the training system 10, for example, which is preferably loaded to and/or from the database through the server database connection script via data packaging code.

If the student or trainee navigates to the list contexts section, a graphical movie screen 152 is displayed that allows the student or trainee to view the various help context topics in connection with the training system 10, for example, which is preferably loaded from the database through the server database connection script via data packaging code.

Alternatively, if the student or trainee wished to query the help section for a particular topic, a logic gate 154 is preferably reached wherein a decision is made to query the help section, and if in the affirmative, a graphical movie screen 156 is displayed that allows the student or trainee to view the results of the query, which are preferably loaded from the database through the server database connection script via data packaging code.

If the student or trainee navigates to the integrated technical chat system section, a graphical movie screen 158 is displayed that allows the student or trainee to view the various help topics concerning the chat system in connection with the training system 10, for example, which is preferably loaded to and/or from the database through the server database connection script via data packaging code.

If the student or trainee navigates to the learning community section (e.g., forums and/or chat sections), a graphical movie screen 160 is displayed that allows the student or trainee to view the various options available therein, for example.

One option available in the learning community section is the integrated user chat section, which when accessed, a graphical movie screen 162 is displayed that allows the student or trainee to chat with other individuals, for example, which is preferably loaded to and/or from the database through the server database connection script via data packaging code.

In accordance with a second preferred embodiment of the present invention, a computerized guided certification program is provided, comprising: (1) a source of subject matter; (2) a subject matter delivery system operable to deliver the subject matter to a user; and (3) an interactive certification system in operable association with the delivery system, wherein the interactive certification system comprises multiple modes of subject matter presentation.

The source of the subject matter can include, without limitation, databases, electronic databases, data containment systems, and data selected from the group consisting of video files, audio files, animation files, database files, graphics files, text files, tabular files, and combinations thereof.

The subject matter delivery system can include, without limitation, computer servers, computer networks, data storage devices, optical mediums (CD, DVD, or the like), transmissions of the subject matter across a wide area network, transmissions of the subject matter across a local area network, transmissions of the subject matter from one data storage device to a second data storage device, and wireless transmissions of the subject matter.

The multiple modes of subject matter presentation can include, without limitation, lectures, exercises, examinations, and combinations thereof.

Furthermore, the interactive certification system preferably includes a user status information system, wherein the user status information system is operable to provide information about the user that can include, without limitation, account information, demographic information, financial information, academic information, and combinations thereof.

Additionally, the interactive certification system preferably includes a randomization system for randomizing the presentation of the subject matter, e.g., a system for randomizing questions of the same difficulty level as well as randomizing the sequence of the presentation of the questions according to level of difficulty.

Also, the interactive certification system preferably includes a certification authorization system, e.g., a system for certifying individuals with respect to competency, proficiency, or the like in connection with a particular subject matter, such as a topic (technical or otherwise), a software program, or the like.

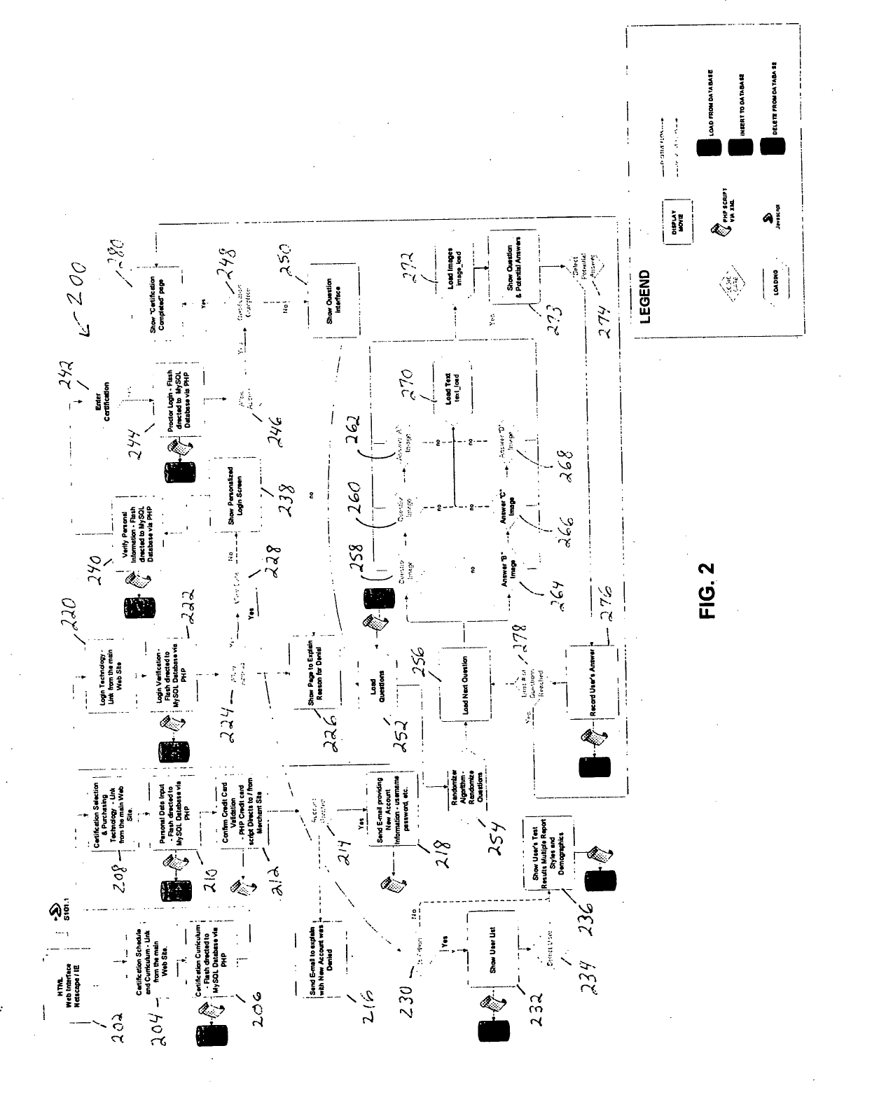

Referring to FIG. 2, there is shown a schematic illustration of a flowchart illustrating the primary processing steps of a certification system, in accordance with a second embodiment of the present invention. As with the previously described training system, the certification system of the present invention can be practiced in conjunction with the Internet, World Wide Web, intranets, extranets, electronic media (e.g., CD/DVD-based systems), or the like. By “certification,” as that term is used herein, it is meant any system for confirming, quantifying, assuring, measuring, or otherwise determining whether an individual has achieved a level, pre-determined or not, of competency, proficiency, expertise, ability, or the like, with respect to any topic, technical or non-technical, including but not limited to software programs. The subject matter that can be certified on is not limited, as it may include any topic including the physical, chemical and/or biological sciences, any type of engineering, including aeronautical, automotive, chemical, civil, computer, electrical, industrial, nuclear, or the like, as well as any other topic, including non-scientific topics. Although the certification system of the present invention will refer generally to certification on software program(s) that have primary application to automotive engineering, it should be appreciated that this is for illustrative purposes only.

Again, as with the previously-described training system, in order to fully appreciate the benefits and features of the certification system of the present invention, it is assumed that an individual practicing the present invention will preferably have: access to a computer (and is conversant with the basic functions thereof); an Internet service provider (“ISP”) (e.g., AOL, JUNO, or the like) with e-mail capability; a Web browser (e.g., INTERNET EXPLORER, NETSCAPE, or the like); any required plug-ins (e.g., FLASH, SHOCKWAVE, JAVA VIRTUAL MACHINE, or the like); and have the ability to navigate successfully to any given uniform resource locator (“URL”).

Preferably, the first step is for the individual to successfully navigate to the URL of the main Web Site that contains the certification system 200 of the present invention (e.g., with the aid of a Web browser, such as INTERNET EXPLORER, NETSCAPE, or the like). By way of a non-limiting example, the URL http://www.scate.com has been designated as the main Web Site for the certification system 200 of the present invention. Once this URL is accessed, it will cause a graphical movie screen 202 (e.g., FLASH, SHOCKWAVE, JAVA, HTML or the like) to be displayed as a result of a action within the HyperText Markup Language (“HTML”) Web interface file (e.g., written with the aid of a programming language, such as but not limited to JavaScript), thus letting the individual know that he has arrived at the correct certification system Web Site.

As with the previously described training system it should be appreciated that the student or trainee will occasionally be required to click on various links in order to navigate to various portions of the Web Site.

The next step is a graphical movie screen 204 that displays, e.g., a certification schedule and curriculum, which is preferably linked from the main Web Site. The certification schedule and curriculum will be dependent, in part, on the number and types of topics that are eligible for certification by the certification system 200.

The next step is a graphical movie screen 206 that displays, e.g., a certification curriculum, which is preferably client-directed to a database, such as but not limited to MySQL or SQL Database (e.g., an open source relational database management system) through a server access database script such as but not limited to PHP script (e.g., a hypertext preprocessor) or ASP (e.g., active server pages) via a data packaging code such as but not limited to XML (e.g., Extensible Markup Language). That is, the certification curriculum is preferably loaded from the database containing that information.

The next step is preferably for a graphical movie screen 208 that displays, e.g., a certification selection and/or purchasing technology, which is preferably linked from the main Web Site.

The next step is for a graphical movie screen 210 that displays, e.g., a request for personal data input, which is preferably client-directed to the database through a server database connection script. That is, the individual's personal data, once input, is loaded to the database designated to receive and store that information.

The next step is for a graphical movie screen 212 that displays, e.g., a confirmation of the credit card validation, wherein a credit card script directs to or from the merchant site through a database connection script via data packaging code. That is, the individual's credit card information is validated so that they can purchase a particular certification program and/or open a new account.

At this point, a logic gate 214 is preferably reached wherein a decision is made whether to open a new account or admit the individual into the certification program, e.g., if the credit card has been approved, or not to open a new account so as to admit the individual into the certification program, e.g., if the credit card was declined or if incorrect information was entered.

If a request for a new account or admission was declined, a graphical movie 216 is preferably displayed that will alert the individual that an e-mail was sent to explain the reason(s) for denial of admission.

If a request for a new account or admission was approved, a graphical movie 218 is preferably displayed that will alert the individual that an e-mail was sent to provide information about the new account such as but not limited to a username, password, and the like, through a server database connection script via data packaging code.

The next step is for a graphical movie screen 220 that displays, e.g., login technology, which is preferably linked from the main Web Site. That is, a login information request page is displayed, so that the individual can log in with his/her username and password, for example.

The next step is for a graphical movie screen 222 that displays, e.g., a login verification, which is preferably client-directed to the database through a server database connection script via data packaging code. That is, the login verification is loaded from and/or loaded to the database designated to send, receive and/or store that information.

At this point, a logic gate 224 is preferably reached wherein a decision is made whether to allow the individual access to the certification program, e.g., if the login verification has occurred without incident, or not to allow the individual access to the certification program, e.g., if the login verification did not occur properly.

If access was not approved, a graphical movie 226 is preferably displayed that will alert the individual that access was denied along with a reason or reasons for the disapproval.

At this point, a logic gate 228 is preferably reached wherein a decision is made regarding access to the test results portion and/or access to the examination portion of the certification program.

If access to the test results portion was approved, a logic gate 230 is preferably reached wherein a decision as to whether the individual is an administrator or a user (e.g., a student or trainee).

If answered in the affirmative, the next step is for a graphical movie screen 232 that displays, e.g., a user list, which is preferably client-directed to the database through a server database connection script via data packaging code.

At this point, a logic gate 234 is preferably reached wherein a decision is made as to which user from the user list is to be selected.

The next step is for a graphical movie screen 236 that displays, e.g., the user's certification test results and other information, which is preferably client-directed from the database through a server database connection script via data packaging code. If the answer to logic gate 230 was answered in the negative, the user is automatically directed to graphical movie screen 236.

If access to the test results portion was not desired, a graphical movie 238 is preferably displayed that will show the individual's personalized login screen.

The next step is for a graphical movie screen 240 that displays, e.g., a display or modification of the individual's personal information, which is preferably client-directed to the database through the server database connection script via data packaging code. That is, the individual's personal information is loaded from the database designated to send and/or store that information.

At this point, a logic gate 242 is preferably reached wherein a decision is made as to whether the user will be allowed to enter the certification program testing section.

The next step is for a graphical movie screen 244 that displays, e.g., a proctor login, which is preferably client-directed to the database through a server database connection script via data packaging code. That is, the proctor login is verified from the database designated to store that information. The proctor login preferably includes information authorizing the user to have access to the certification program, e.g., through a third party, such as the Society of Automotive Engineers.

At this point, a logic gate 246 is preferably reached wherein a decision is made as to whether the user will be allowed access to the proctored certification program.

If access was not approved, a graphical movie 226 is preferably displayed that will alert the individual that access was denied along with a reason or reasons for the disapproval.

If access to the proctored certification program is granted, a logic gate 248 is preferably reached wherein a decision is made as to whether the certification program is complete or not.

If the answer is in the negative, the next step is for a graphical movie screen 250 that displays, e.g., show question interface, which alerts the user that he/she is about to view the questions of the certification program, which is preferably client-directed to the database through a server database connection script via data packaging code.

The next step is for a loading point 252 to be reached that, e.g., loads the questions of the certification program, which is preferably client-directed to the database through a server database connection script via data packaging code.

The next step is for a loading point 254 to be reached that, e.g., randomizes the questions of the certification program via a randomizer algorithm, which causes the randomization of the questions based upon skill set ratio, including but not limited to level of difficulty.

The next step is for a graphical movie screen 256 that displays, e.g., load next question, which causes the next question to load and be displayed.

At this point, several logic gates are preferably reached, including a question image logic gate 258, a chart image logic gate 260, and several answer choice image logic gates 262, 264, 266, 268, respectively. If the answers to these image logic gates is in the negative, a loading point 270 is preferably reached wherein the text of the questions and/or answers are loaded from a server, which preferably can be delivered by the provider of the certification system 200. If the answers to these image gates is in the affirmative, an additional loading point 272 is preferably reached wherein the images associated with the questions and/or answers are loaded from a server, which preferably can be delivered by the provider of the certification system 200. It should be appreciated that a combination of text and animation and/or graphics may be displayed.

The next step is for a graphical movie screen 273 that displays, e.g., the question and associated potential answers, which permits the user to see the question and associated potential answers on a single screen.

At this point, a logic gate 274 is preferably reached wherein a decision is made as to which potential answer to the question is selected.

If an answer is selected, the next step is for a graphical movie screen 276 that displays, e.g., record user's answer, which causes the answer to be recorded, which is preferably client-directed to the database through a server database connection script via data packaging code.

At this point, a logic gate 278 is preferably reached wherein a decision is made as to whether the limit of questions has been reached, i.e., are there any more questions to be answered in the certification program.

If the answer is in the negative, the next step is for graphical movie screen 256 that displays, e.g., load next question, which causes the next question to load and be displayed.

If the answer is in the affirmative, the next step is for graphical movie screen 280 that displays, e.g., certification completed, i.e., the certification program is over. Optionally, the questions will be graded and the user will be notified of the results.

In accordance with a third preferred embodiment of the present invention, a courseware development system for a computerized guided training or certification system is provided, comprising: (1) a subject matter delivery system operable to deliver a source of subject matter to a user; and (2) a subject matter management system in operable association with the delivery system, wherein the subject matter management system is operable to dynamically create, delete, or modify subject matter.

The source of the subject matter can include, without limitation, databases, electronic databases, data containment systems, and data selected from the group consisting of video files, audio files, animation files, database files, graphics files, text files, tabular files, and combinations thereof.

The subject matter delivery system can include, without limitation, computer servers, computer networks, data storage devices, optical mediums (CD, DVD, or the like), transmissions of the subject matter across a wide area network, transmissions of the subject matter across a local area network, transmissions of the subject matter from one data storage device to a second data storage device, and wireless transmissions of the subject matter.

The subject matter management system is preferably operable to modify multiple modes of subject matter presentation, wherein the presentation of multiple modes of subject matter presentation can include, without limitation, text, video, audio, graphics, animation, and combinations thereof.

Furthermore, the subject matter management system of the present invention preferably includes a user access control system, e.g., a system controlling whether a student or trainee has access to a particular course.

It should be appreciated that the courseware management system is intended primarily for use by the content providers, e.g., of the previously-described training and/or certification programs, as opposed to students or trainees.

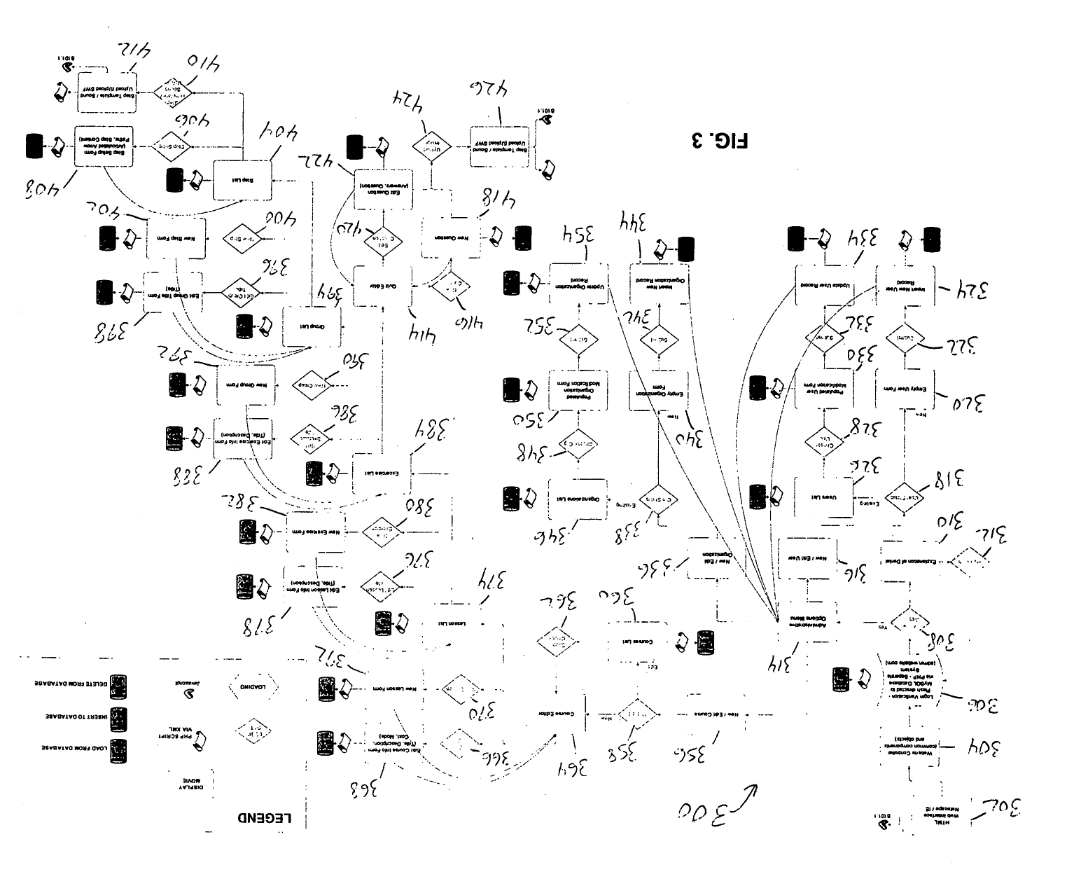

Referring to FIG. 3, there is shown a schematic illustration of a flowchart illustrating the primary processing steps of a courseware development system, in accordance with a third embodiment of the present invention. As with the previously described training and certification systems, the courseware development system of the present invention can be practiced in conjunction with the Internet, World Wide Web, intranets, extranets, electronic media (e.g., CD/DVD-based systems), or the like. By “courseware development,” as that phrase is used herein, it is meant any system for creating, modifying and/or deleting subject matter regarding any topic, including the forms and/or mediums comprising that subject matter, with respect to any topic, technical or non-technical, including but not limited to software programs. The subject matter that can be managed is not limited, as it may include any topic including the physical, chemical and/or biological sciences, any type of engineering, including aeronautical, automotive, chemical, civil, computer, electrical, industrial, nuclear, or the like, as well as any other topic, including non-scientific topics. Although the courseware management system of the present invention will refer generally to courseware management of software program(s) that have primary application to automotive engineering, it should be appreciated that this is for illustrative purposes only.

Again, as with the previously-described training and certification systems, in order to fully appreciate the benefits and features of the courseware management system of the present invention, it is assumed that an individual practicing the present invention will preferably have: access to a computer (and is conversant with the basic functions thereof); an Internet service provider (“ISP”) (e.g., AOL, JUNO, or the like) with e-mail capability; a Web browser (e.g., INTERNET EXPLORER, NETSCAPE, or the like); any required plug-ins (e.g., FLASH, SHOCKWAVE, JAVA VIRTUAL MACHINE, or the like); and have the ability to navigate successfully to any given uniform resource locator (“URL”).

Preferably, the first step is for the individual to successfully navigate to the URL of the main Web Site that contains the courseware management system 300 of the present invention (e.g., with the aid of a Web browser, such as INTERNET EXPLORER, NETSCAPE, or the like). By way of a non-limiting example, the URL http://www.scate.com has been designated as the main Web Site for the courseware management system 300 of the present invention. Once this URL is accessed, it will cause a graphical movie screen 302 (e.g., FLASH, SHOCKWAVE, JAVA, HTML or the like) to be displayed as a result of a action within the HyperText Markup Language (“HTML”) Web interface file (e.g., written with the aid of a programming language, such as but not limited to JavaScript), thus letting the individual know that he has arrived at the correct courseware management system Web Site.

As with the previously described training and certification systems, it should be appreciated that the user will occasionally be required to click on various links in order to navigate to various portions of the Web Site.

The next step is for a graphical movie screen 304 that displays, e.g., website controller.

The next step is for a graphical movie screen 306 that displays, e.g., a login verification, which is preferably client-directed to the database through a server database connection script via data packaging code.

At this point, a logic gate 308 is preferably reached wherein a decision is made whether to allow the individual access to the courseware management system.

If access was not approved, a graphical movie 310 is preferably displayed that will alert the individual that access was denied along with a reason or reasons for the disapproval.

If access to the courseware management system was not granted, a logic gate 312 is preferably reached wherein a decision is made as to whether another login attempt should be made or not. If this is answered in the affirmative, the next step is for graphical movie screen 306 to be displayed, e.g., a login verification, which is preferably client-directed to the database through a server database connection script via data packaging code.

If access was approved, the next step is for a graphical movie screen 314 that displays, e.g., an administrative options menu. From this menu, the administrator (e.g., content provider) has several options available to him/her regarding the creation, deletion and/or modification of the subject matter and presentation and/or form thereof, as well as actions concerning the user of the associated training and/or certification programs, previously described.

If the administrator wishes to create a new user entry or edit a current user entry, the next step is for a graphical movie screen 316 that displays, e.g., new/edit user.

At this point, a logic gate 318 is preferably reached wherein a decision is made as to whether the user is new or current.

If the user is new, the next step is for a graphical movie screen 320 that displays, e.g., empty user form, i.e., a form for entering information about the new user is displayed.

At this point, a logic gate 322 is preferably reached wherein a decision is made as to whether to submit the information regarding the new user.

If the answer is in the affirmative, the next step is for a graphical movie screen 324 that displays, e.g., insert new user record, i.e., the information about the new user was recorded and entered into the database, which is preferably client-directed to the database through a server database connection script via data packaging code.

At this point, the administrator can loop back to the administrative options menu screen 314.

If, however, the user is a current student or trainee, the next step is for a graphical movie screen 326 that displays, e.g., the user's list, i.e., a listing of all current students or trainees, which is preferably client-directed to the database through a server database connection script via data packaging code.

At this point, a logic gate 328 is preferably reached wherein a decision is made as to which particular current user's record is to be selected for processing.

The next step is for a graphical movie screen 330 that displays, e.g., a populated user modification form, i.e., a form which allows the administrator to modify the current user's information, which is preferably client-directed to the database through a server database connection script via data packaging code.

At this point, a logic gate 332 is preferably reached wherein a decision is made as to whether to submit the information regarding the current user.

If the answer is in the affirmative, the next step is for a graphical movie screen 334 that displays, e.g., update user record, i.e., the information about the current user was recorded and entered into the database, which is preferably client-directed to the database through a server database connection script via data packaging code. At this point, the administrator can loop back to the administrative options menu screen 314.

Alternatively, if the administrator wishes to create a new organization entry or edit a current organization entry, the next step is for a graphical movie screen 336 that displays, e.g., new/edit organization.

At this point, a logic gate 338 is preferably reached wherein a decision is made as to whether the organization's status is new or current.

If the organization is new, the next step is for a graphical movie screen 340 that displays, e.g., empty organization form, i.e., a form for entering information about the new organization is displayed.

At this point, a logic gate 342 is preferably reached wherein a decision is made as to whether to submit the information regarding the new organization.

If the answer is in the affirmative, the next step is for a graphical movie screen 344 that displays, e.g., insert new organization record, i.e., the information about the new organization was recorded and entered into the database, which is preferably client-directed to the database through a server database connection script via data packaging code. At this point, the administrator can loop back to the administrative options menu screen 314.

If, however, the organization is a current organization, the next step is for a graphical movie screen 346 that displays, e.g., the organization's list, i.e., a listing of all current organizations, which is preferably client-directed to the database through a server database connection script via data packaging code.

At this point, a logic gate 348 is preferably reached wherein a decision is made as to which particular current organization's record is to be selected for processing.

The next step is for a graphical movie screen 350 that displays, e.g., a populated organization modification form, i.e., a form which allows the administrator to modify the current organization's information, which is preferably client-directed to the database through a server database connection script via data packaging code.

At this point, a logic gate 352 is preferably reached wherein a decision is made as to whether to submit the information regarding the current organization.

If the answer is in the affirmative, the next step is for a graphical movie screen 354 that displays, e.g., update organization record, i.e., the information about the current organization was recorded and entered into the database, which is preferably client-directed to the database through a server database connection script via data packaging code. At this point, the administrator can loop back to the administrative options menu screen 314.

If the administrator wishes to create a new course or edit a current course, the next step is for a graphical movie screen 356 that displays, e.g., new/edit course.

At this point, a logic gate 358 is preferably reached wherein a decision is made as to whether to create a new course or edit an existing course.

If the decision is made to edit an existing course, the next step is for a graphical movie screen 360 that displays, e.g., a course list, i.e., a listing of all of the existing courses, which is preferably client-directed to the database through a server database connection script via data packaging code.

At this point, a logic gate 362 is preferably reached wherein a decision is made as to which existing course is to be chosen for processing.

If, however, the course is new and needs to be created, the next step is for a graphical movie screen 364 that displays, e.g., the course editor, i.e., an entry point for creating, deleting and/or modifying the course content. Additionally, a decision to modify an existing course will also lead to graphical movie screen 364, as shown.

At this point, a logic gate 366 is preferably reached wherein a decision is made as to whether to edit the course information, such as the title, description, cost, mode, or the like.

If the decision is made to edit the course information, the next step is for a graphical movie screen 368 that displays, e.g., an edit course information form, i.e., a form for editing the course information, which is preferably client-directed to the database through a server database connection script via data packaging code. At this point, the administrator can loop back to the administrative options menu screen 314.

Alternatively, another logic gate 370 is preferably reached wherein a decision is made as to whether to add a new lesson to the course, i.e., additional subject matter content is to be added to the course.

If the decision is made to edit the course information, the next step is for a graphical movie screen 372 that displays, e.g., a new lesson form, i.e., a form for adding a new lesson to the course, which is preferably client-directed to the database through a server database connection script via data packaging code. At this point, the administrator can loop back to the administrative options menu screen 314.

Additionally, the administrator can instead choose to add, delete and/or modify the lesson list, wherein the next step is for a graphical movie screen 374 that displays, e.g., a lesson list.

At this point, a logic gate 376 is preferably reached wherein a decision is made as to whether to edit the lesson information, such as the title, description, or the like.

If the decision is made to edit the lesson information, the next step is for a graphical movie screen 378 that displays, e.g., an edit lesson information form, i.e., a form for editing an existing lesson to the course, which is preferably client-directed to the database through a server database connection script via data packaging code. At this point, the administrator can loop back to the lesson list screen 374.

Alternatively, another logic gate 380 is preferably reached wherein a decision is made as to whether to add a new exercise to the course, i.e., additional subject matter content is to be added to the course.

If the decision is made to add a new exercise, the next step is for a graphical movie screen 382 that displays, e.g., a new exercise form, i.e., a form for adding a new exercise to the course, which is preferably client-directed to the database through a server database connection script via data packaging code. At this point, the administrator can loop back to the lessons list screen 374.

Additionally, the administrator can instead choose to add, delete and/or modify the exercise list, wherein the next step is for a graphical movie screen 384 that displays, e.g., an exercise list.

At this point, a logic gate 386 is preferably reached wherein a decision is made as to whether to edit the exercise information, such as the title, description, or the like.

If the decision is made to edit the exercise information, the next step is for a graphical movie screen 388 that displays, e.g., an edit exercise information form, i.e., a form for editing an existing exercise to the course, which is preferably client-directed to the database through a server database connection script via data packaging code. At this point, the administrator can loop back to the exercise list screen 384.

Alternatively, another logic gate 390 is preferably reached wherein a decision is made as to whether to add a new group to the course, i.e., additional subject matter content is to be added to the course.

If the decision is made to add a new group, the next step is for a graphical movie screen 392 that displays, e.g., a new group form, i.e., a form for adding a new group to the course, which is preferably client-directed to the database through a server database connection script via data packaging code. At this point, the administrator can loop back to the exercise list screen 384.

Additionally, the administrator can instead choose to add, delete and/or modify the group list, wherein the next step is for a graphical movie screen 394 that displays, e.g., a group list, which is preferably client-directed to the database through a server database connection script via data packaging code.

At this point, a logic gate 396 is preferably reached wherein a decision is made as to whether to edit the group title information.

If the decision is made to edit the group title information, the next step is for a graphical movie screen 398 that displays, e.g., an edit group title information form, i.e., a form for editing an existing group title, which is preferably client-directed to the database through a server database connection script via data packaging code. At this point, the administrator can loop back to the group list screen 394.

Alternatively, another logic gate 400 is preferably reached wherein a decision is made as to whether to add a new step to the course, i.e., additional subject matter content is to be added to the course.

If the decision is made to add a new step, the next step is for a graphical movie screen 402 that displays, e.g., a new step form, i.e., a form for adding a new step to the course, which is preferably client-directed to the database through a server database connection script via data packaging code. At this point, the administrator can loop back to the group list screen 394.

Additionally, the administrator can instead choose to add, delete and/or modify the step list, wherein the next step is for a graphical movie screen 404 that displays, e.g., a step list, which is preferably client-directed to the database through a server database connection script via data packaging code.

At this point, a logic gate 406 is preferably reached wherein a decision is made as to whether to setup a step.

If the decision is made to setup a step, the next step is for a graphical movie screen 408 that displays, e.g., a step setup form, i.e., a form for setting up a step, which is preferably client-directed to the database through a server database connection script via data packaging code. At this point, the administrator can loop back to the step list screen 404.

Alternatively, another logic gate 410 is preferably reached wherein a decision is made as to whether to add a step template and/or sound upload to the course, i.e., additional subject matter content is to be added to the course.

If the decision is made to add a step template and/or a sound upload, the next step is for a graphical movie screen 412 that displays, e.g., a point for uploading subject matter content, i.e., including but not limited to templates, sound files, in conjunction with a question, which is preferably client-directed to the database through a server database connection script via data packaging code.

Additionally, the administrator can instead choose to add, delete and/or modify the quiz editor, wherein the next step is for a graphical movie screen 414 that displays, e.g., quiz editor or list, which is preferably client-directed to the database through a server database connection script via data packaging code.

A logic gate 416 is preferably reached wherein a decision is made as to whether the question is a new question or an existing question.

If the question is new, the next step is for a graphical movie screen 418 that displays, e.g., a new question, i.e., a point for entering the new question to the course, which is preferably client-directed to the database through a server database connection script via data packaging code. At this point, the administrator can loop back to the quiz editor screen 414.

Alternatively, another logic gate 420 is preferably reached wherein a decision is made as to whether to edit an existing question.

If the decision is made to edit an existing question, the next step is for a graphical movie screen 422 that displays, e.g., edit question, i.e., a point for editing an existing question as well as the answers associated therewith, which is preferably client-directed to the database through a server database connection script via data packaging code. At this point, the administrator can loop back to the quiz editor screen 414.

If an image is desired to be uploaded with respect to a newly added question or an existing question, still another logic gate 424 is preferably reached wherein a decision is made as to whether to upload an image in conjunction with a question.

If the decision is made to upload an image, the next step is for a graphical movie screen 426 that displays, e.g., a point for uploading subject matter content, i.e., including but not limited to templates, sound files, in conjunction with a question, which is preferably client-directed to the database through a server database connection script via data packaging code.

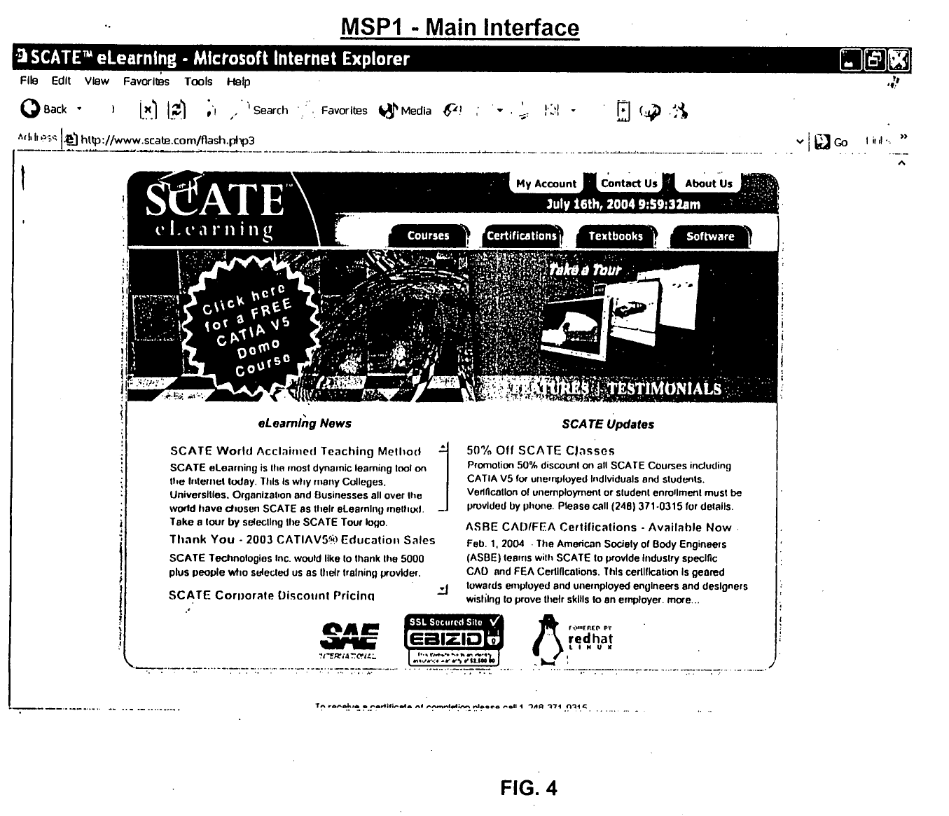

In order to demonstrate the various features of the present invention, as well as the user-friendliness of the present invention, several screen captures are presented in FIGS. 4-43, the descriptions of which are presented below.

FIGS. 4-10 generally relate to the main website of the provider of the training and/or certification programs of the present invention.

Referring to FIG. 4, there is shown a screen capture illustrating a main interface screen of a training/certification system, in accordance with a fourth embodiment of the present invention.

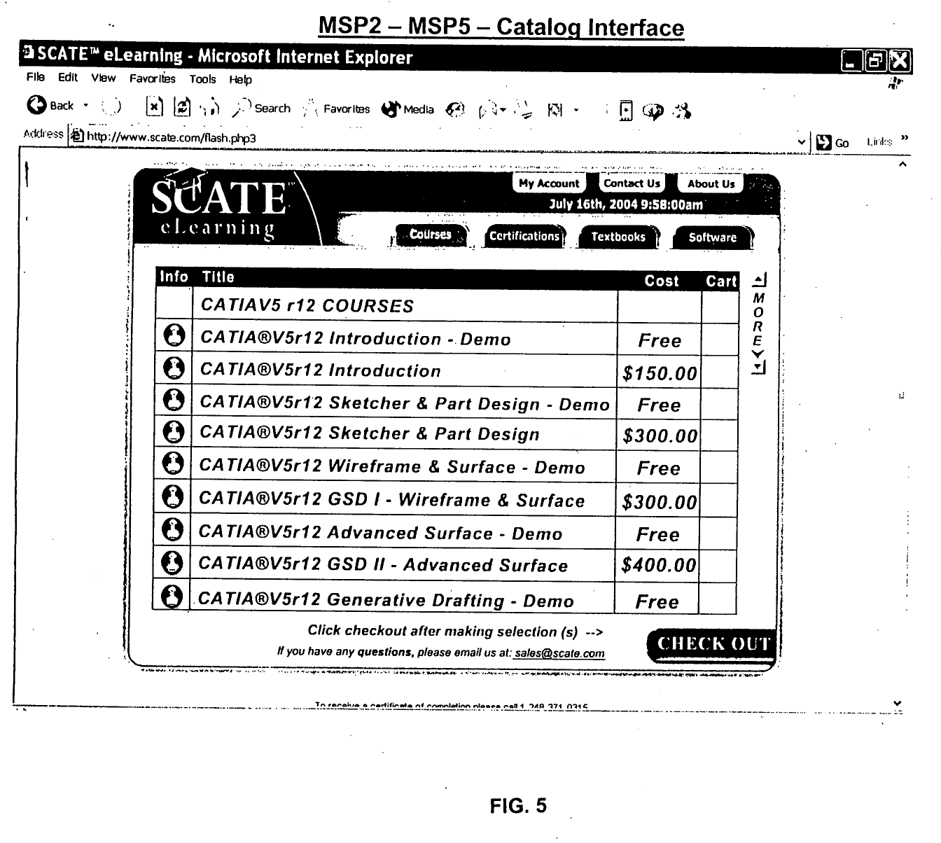

Referring to FIG. 5, there is shown a screen capture illustrating a catalog interface screen of a training/certification system, in accordance with a fourth embodiment of the present invention.

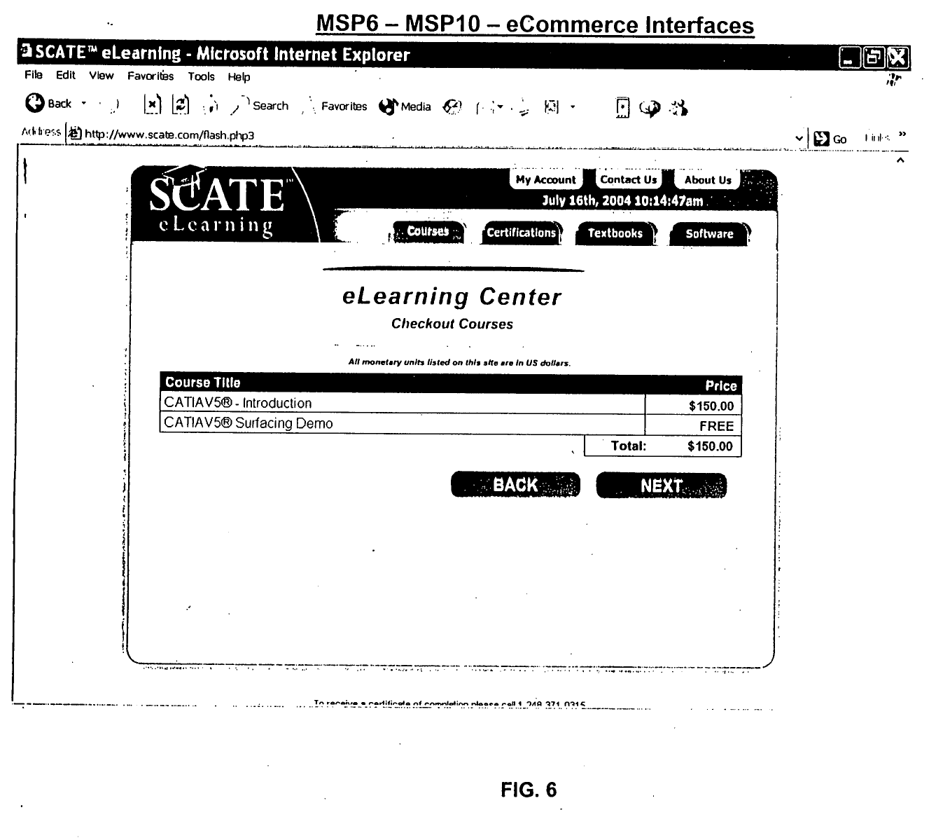

Referring to FIG. 6, there is shown a screen capture illustrating an e-commerce interface screen of a training/certification system, in accordance with a fourth embodiment of the present invention.

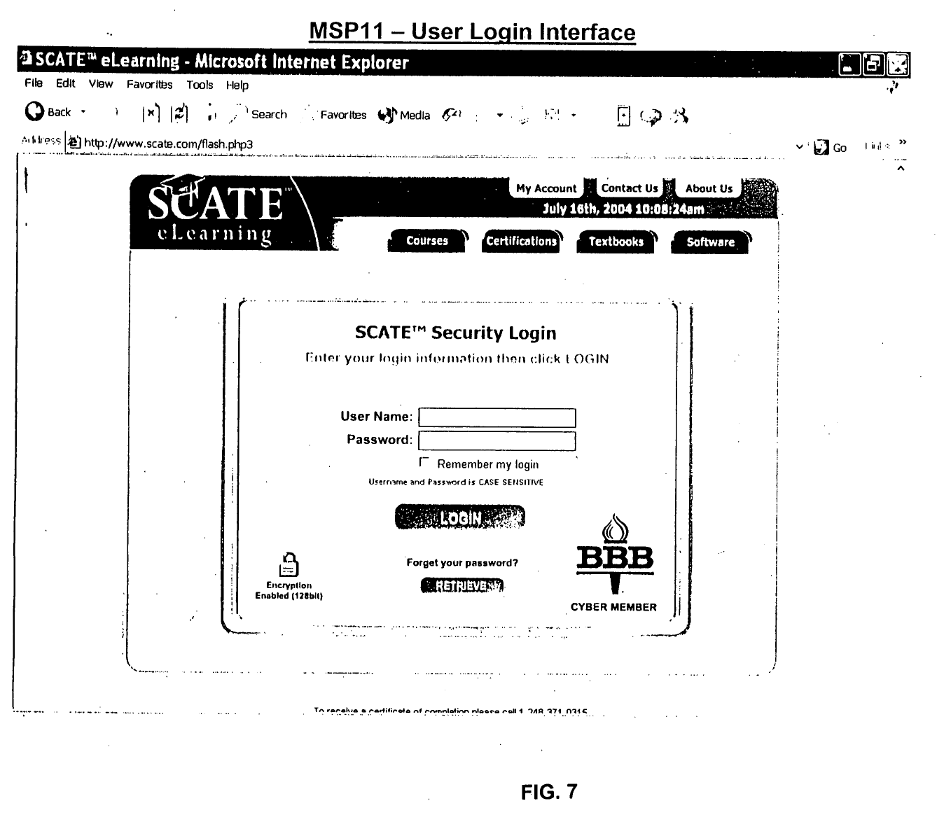

Referring to FIG. 7, there is shown a screen capture illustrating a user login interface screen of a training/certification system, in accordance with a fourth embodiment of the present invention.

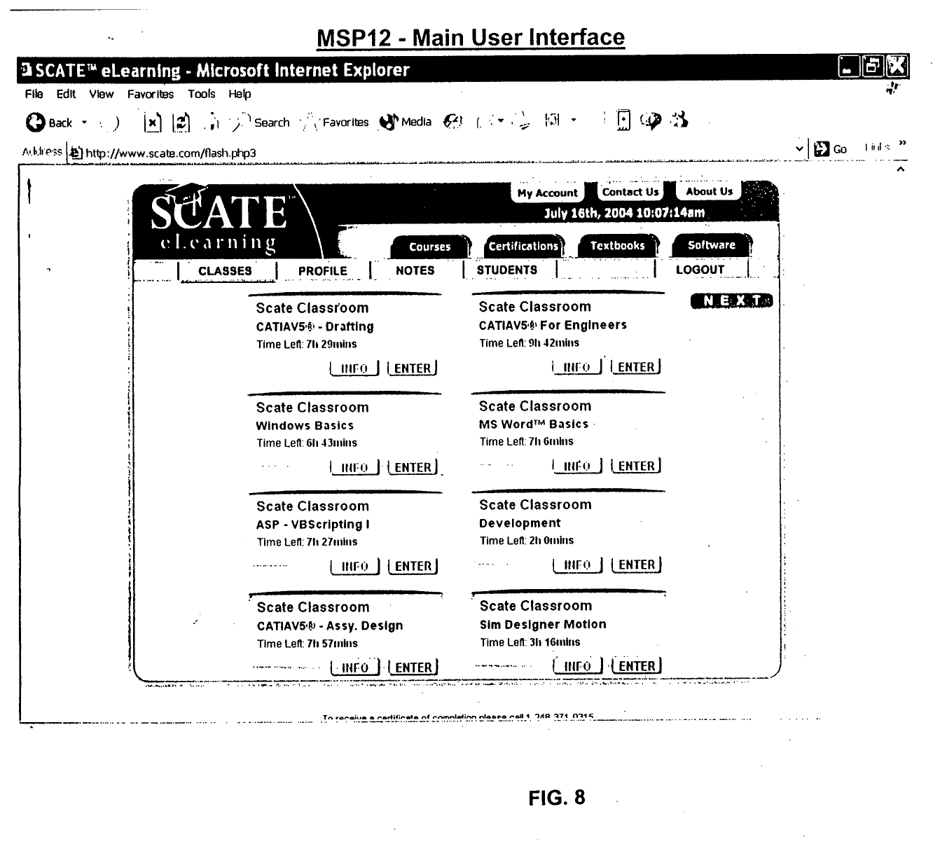

Referring to FIG. 8, there is shown a screen capture illustrating a main user interface screen of a training/certification system, in accordance with a fourth embodiment of the present invention.

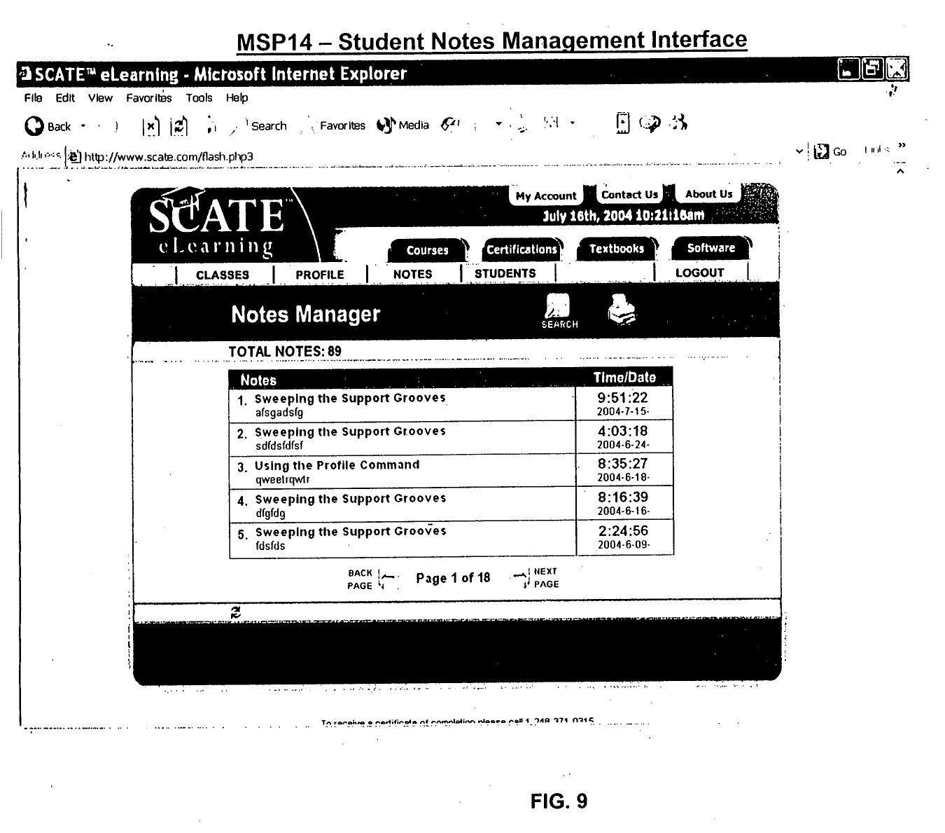

Referring to FIG. 9, there is shown a screen capture illustrating a student notes management interface screen of a training/certification system, in accordance with a fourth embodiment of the present invention.

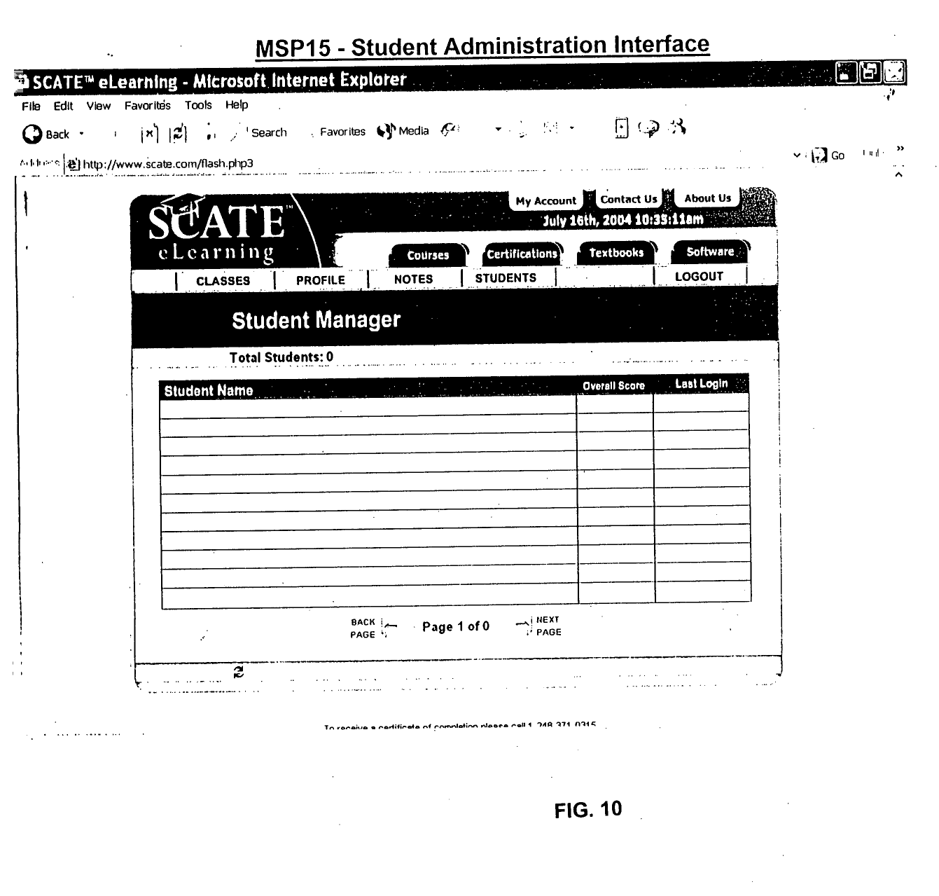

Referring to FIG. 10, there is shown a screen capture illustrating a student administration interface screen of a training/certification system, in accordance with a fourth embodiment of the present invention. This screen allows a student manager to administer students, student records, login times, and other administerial functions within his/her authority.

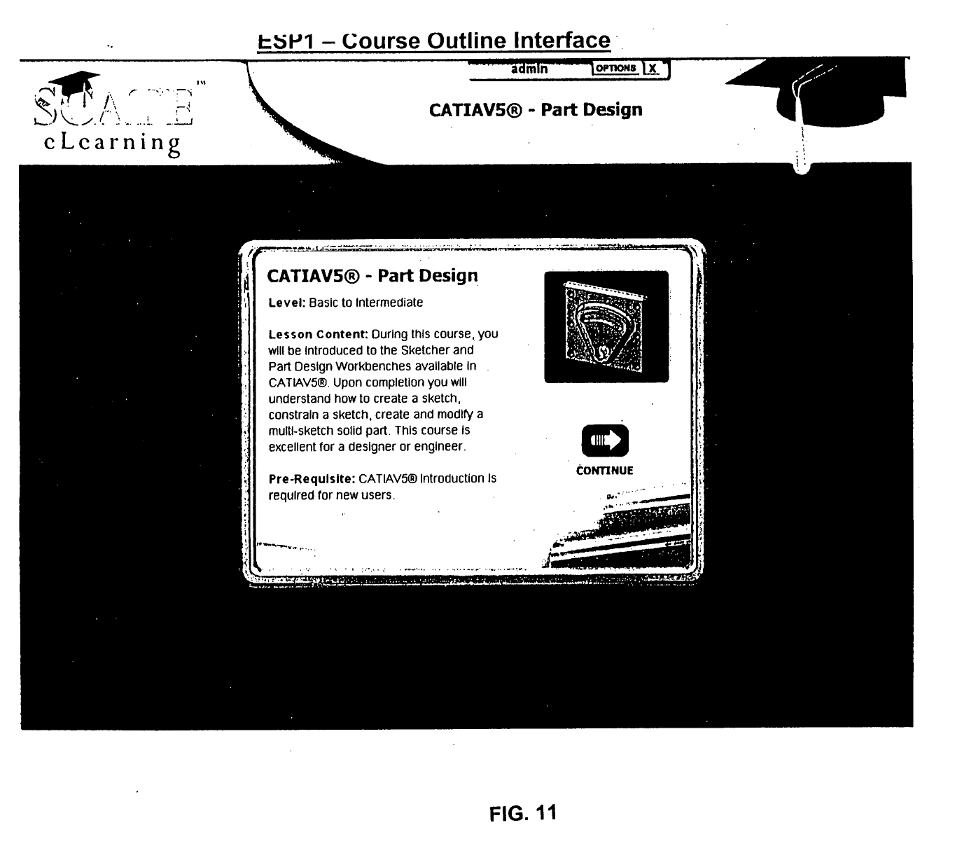

FIGS. 11-28 generally relate to the main website of the provider, with specific reference to several aspects of the training program of the present invention.

Referring to FIG. 11, there is shown a screen capture illustrating a course outline interface screen of a training system, in accordance with a fifth embodiment of the present invention. This screen embodies the commencement of ILA shell feature of the present invention.

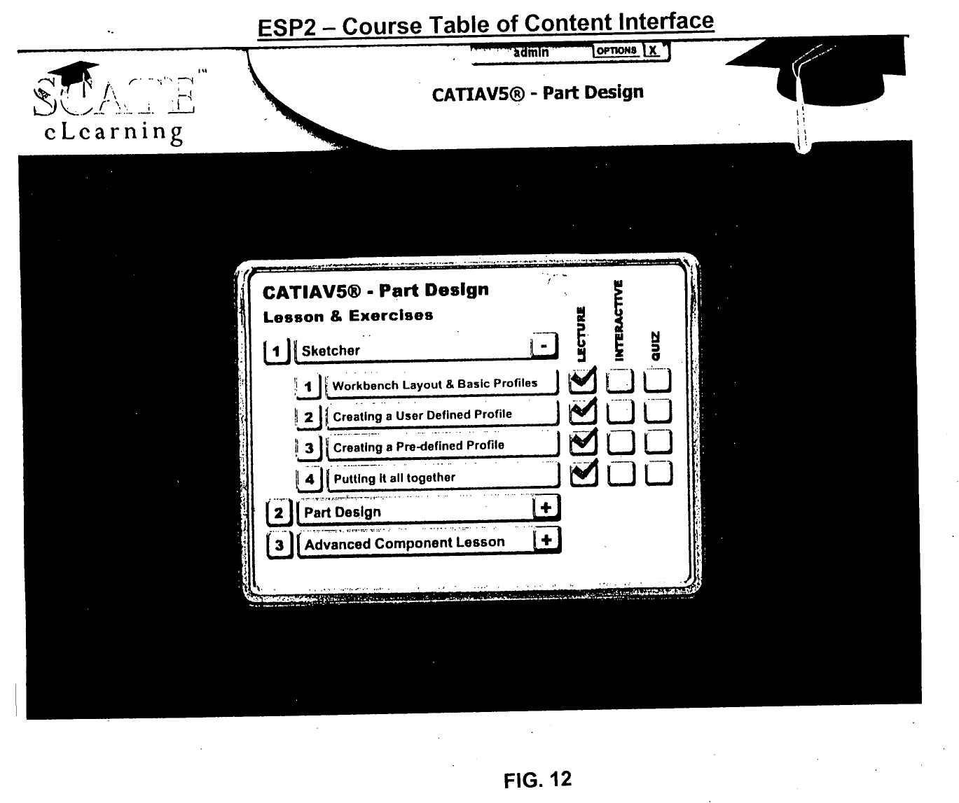

Referring to FIG. 12, there is shown a screen capture illustrating a course table of contents interface screen of a training system, in accordance with a fifth embodiment of the present invention. This screen displays lessons and exercises and the three main learning modes, lecture, interactive and quiz, and their completion status.

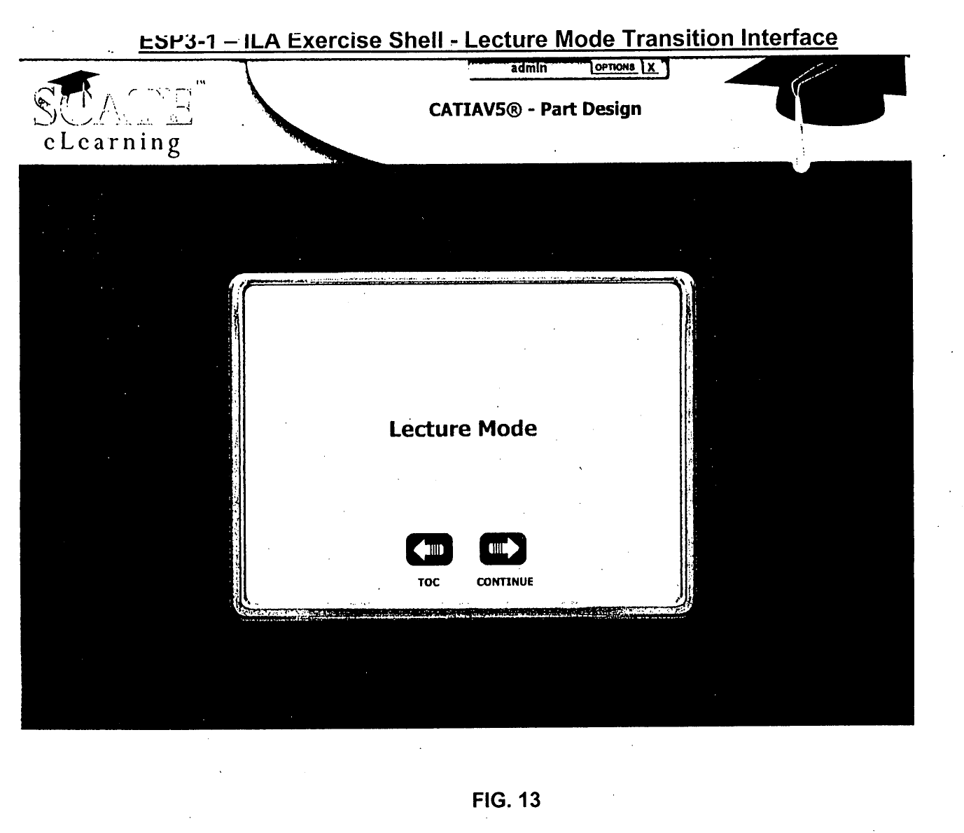

Referring to FIG. 13, there is shown a screen capture illustrating a lecture mode transition interface screen of a training system, in accordance with a fifth embodiment of the present invention.

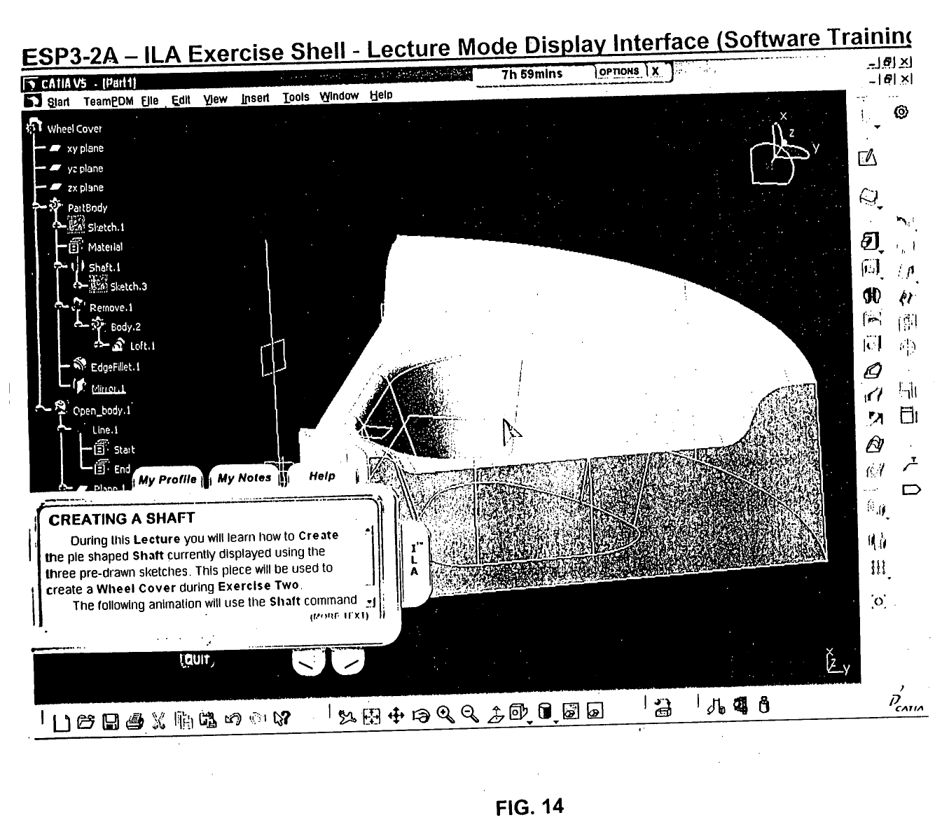

Referring to FIG. 14, there is shown a screen capture illustrating a lecture mode display interface (software training) screen of a training system, in accordance with a fifth embodiment of the present invention. By way of a non-limiting example, this screen illustrates a lecture concerning the software application, CATIA Version 5, an automotive engineering software package. However, it should be appreciated that this is for illustrative purposes only. The features of the present invention for software training shown in this view include the ILA text display box and feature/navigation control center shown in the lower left hand portion of the screen, as well as a time display and options menu shown along the top of the screen. This feature allows the student to view guided step-by-step instructions received from the ILA feature of the present invention.

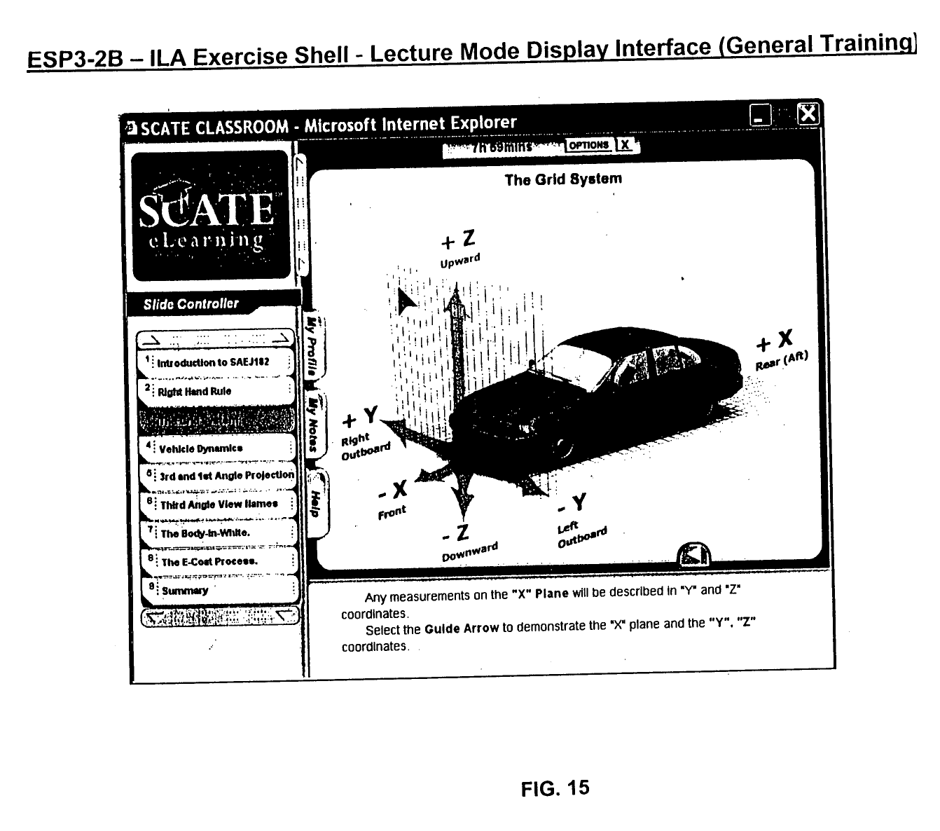

Referring to FIG. 15, there is shown a screen capture illustrating a lecture mode display interface (general training) screen of a training system, in accordance with a fifth embodiment of the present invention. The features of the present invention for general training shown in this view include the ILA text display box and feature/navigation control center shown along the left and bottom portions of the screen, as well as a time display and options menu shown along the top of the screen. This feature allows the student to view guided step-by-step instructions received from the ILA feature of the present invention.

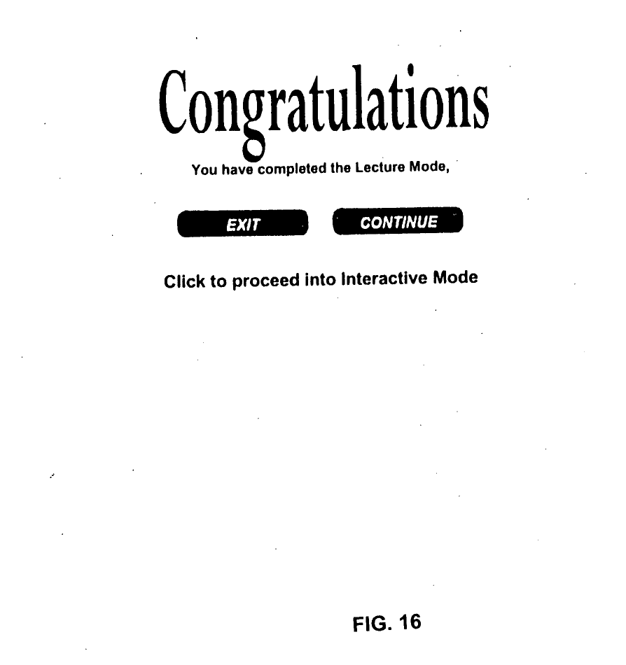

Referring to FIG. 16, there is shown a screen capture illustrating a lecture completion interface (software training) screen of a training system, in accordance with a fifth embodiment of the present invention.

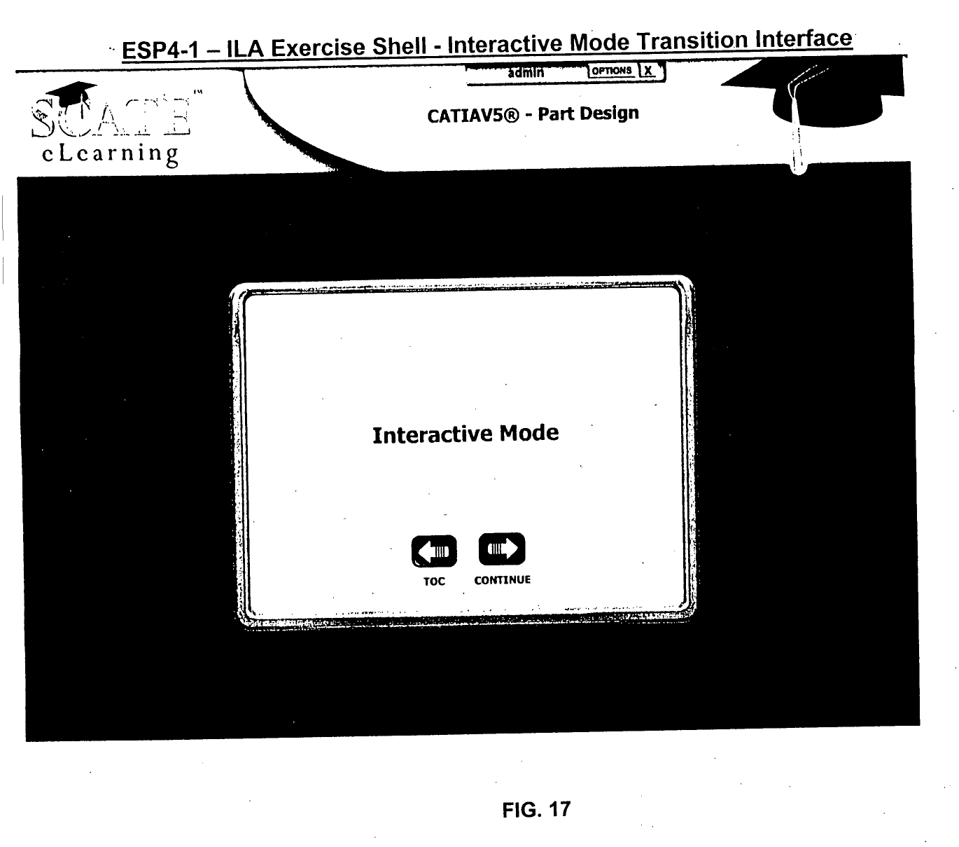

Referring to FIG. 17, there is shown a screen capture illustrating an interactive mode transition interface screen of a training system, in accordance with a fifth embodiment of the present invention.

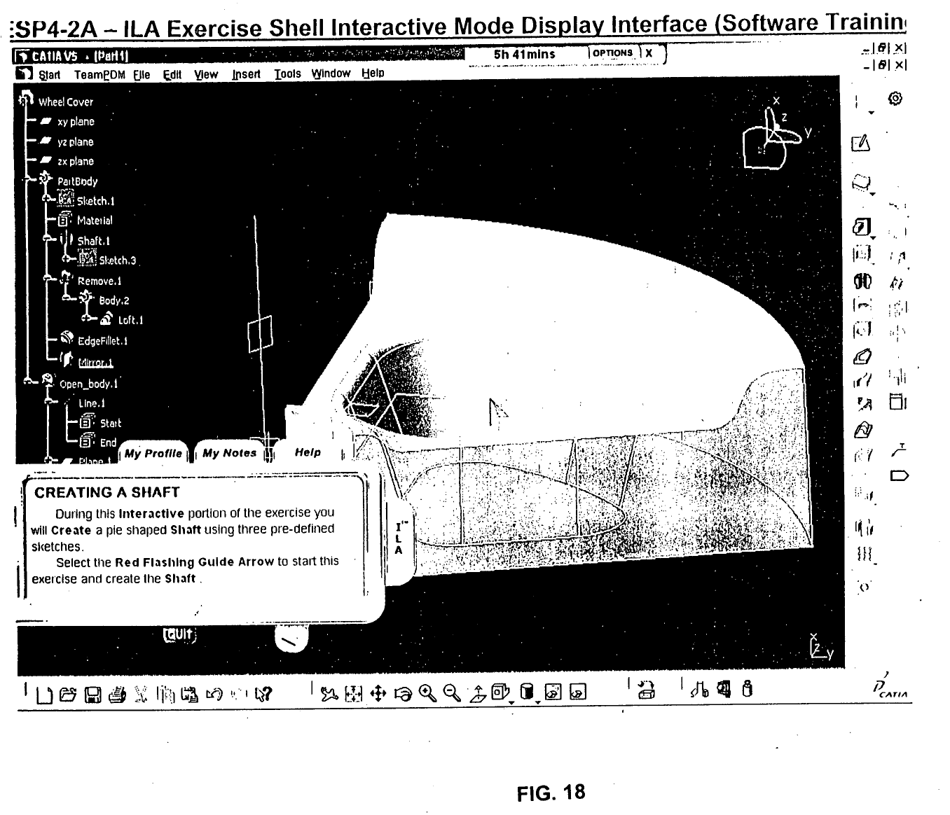

Referring to FIG. 18, there is shown a screen capture illustrating an interactive mode display interface (software training) screen of a training system, in accordance with a fifth embodiment of the present invention. The features of the present invention for software training shown in this view include the ILA text display box and feature/navigation control center shown in the lower left hand portion of the screen, as well as a time display and options menu shown along the top of the screen. This feature allows the student to carry out guided step-by-step instructions received from the ILA feature of the present invention.

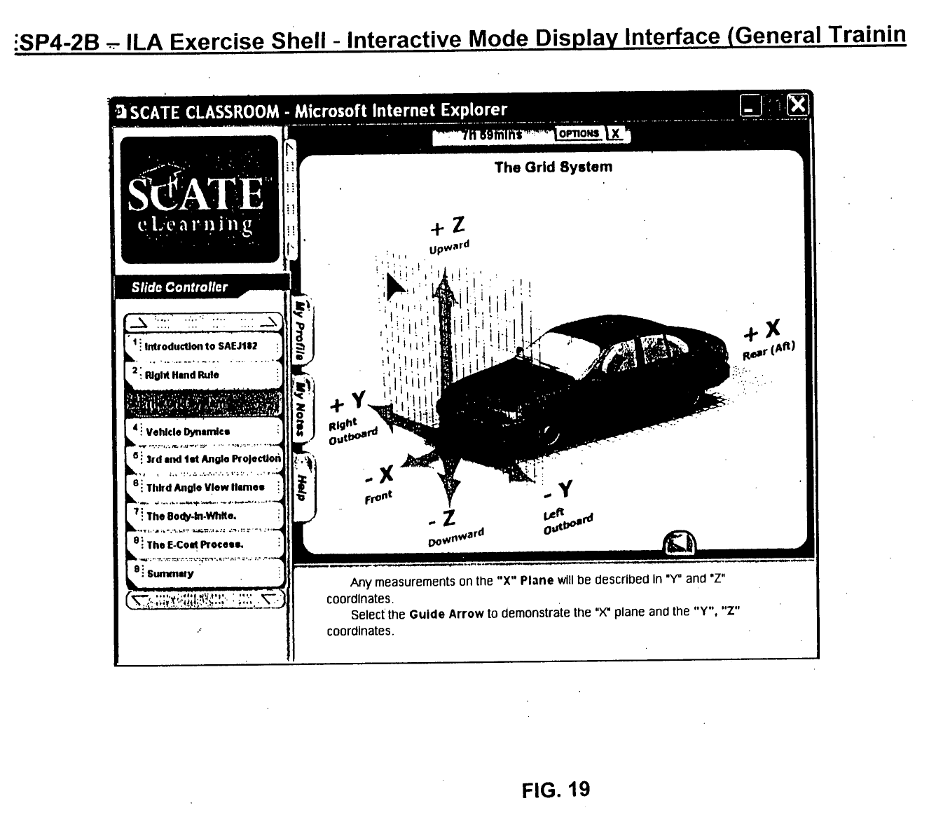

Referring to FIG. 19, there is shown a screen capture illustrating an interactive mode display interface (general training) screen of a training system, in accordance with a fifth embodiment of the present invention. The features of the present invention for software training shown in this view include the ILA text display box and feature/navigation control center shown along the left and bottom portions of the screen, as well as a time display and options menu shown along the top of the screen. This feature allows the student to carry out guided step-by-step instructions received from the ILA feature of the present invention.

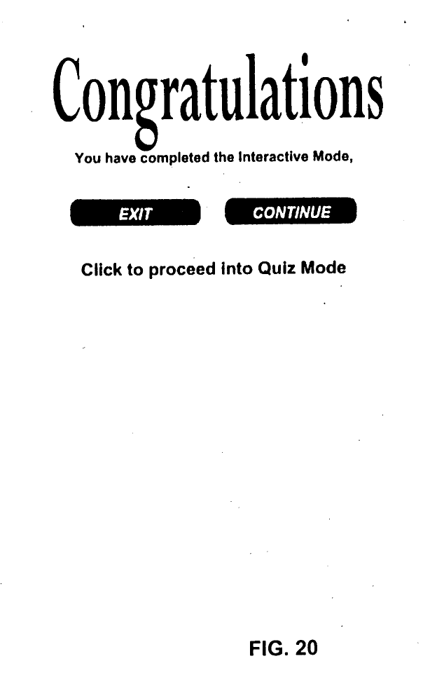

Referring to FIG. 20, there is shown a screen capture illustrating an interactive completion interface (software training) screen of a training system, in accordance with a fifth embodiment of the present invention.

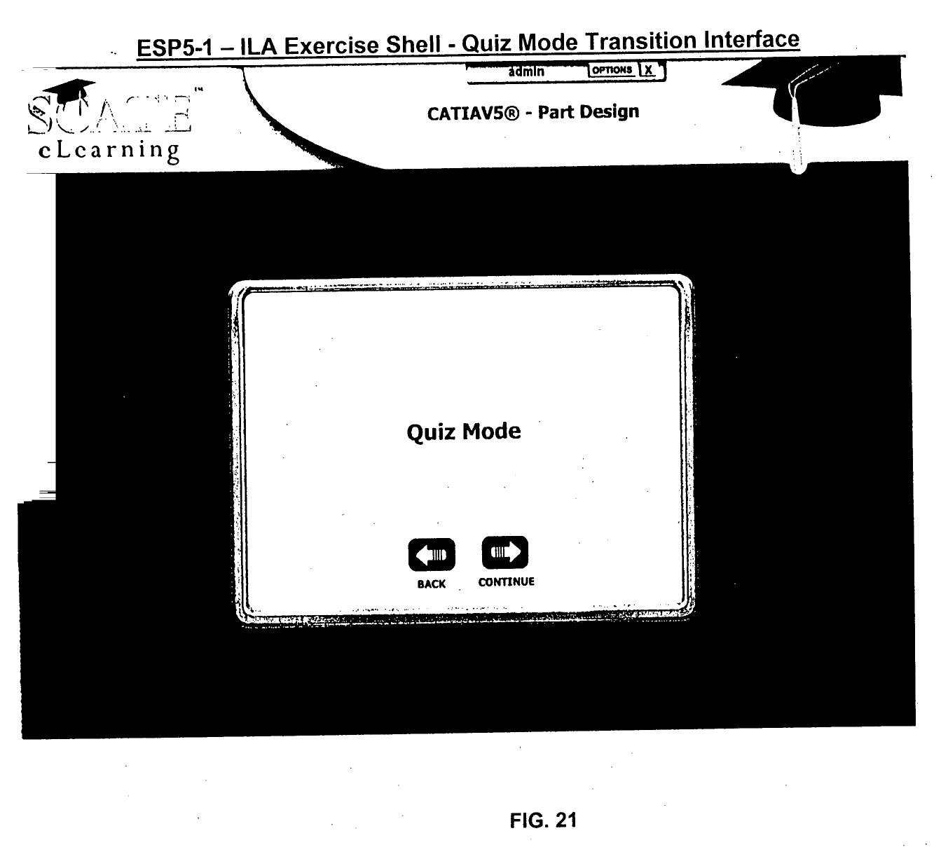

Referring to FIG. 21, there is shown a screen capture illustrating a quiz mode transition interface screen of a training system, in accordance with a fifth embodiment of the present invention.

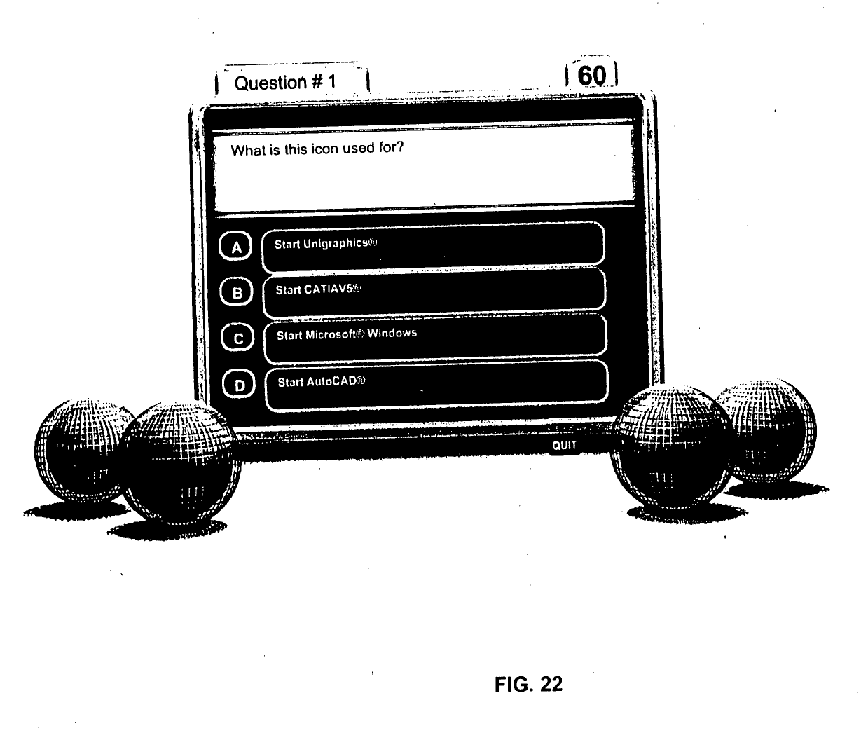

Referring to FIG. 22, there is shown a screen capture illustrating a quiz mode display interface (software training) screen of a training system, in accordance with a fifth embodiment of the present invention. This feature can include a question timer system associated therewith. Additionally, rapid feedback is available to inform the student as to whether the question was correctly answered.

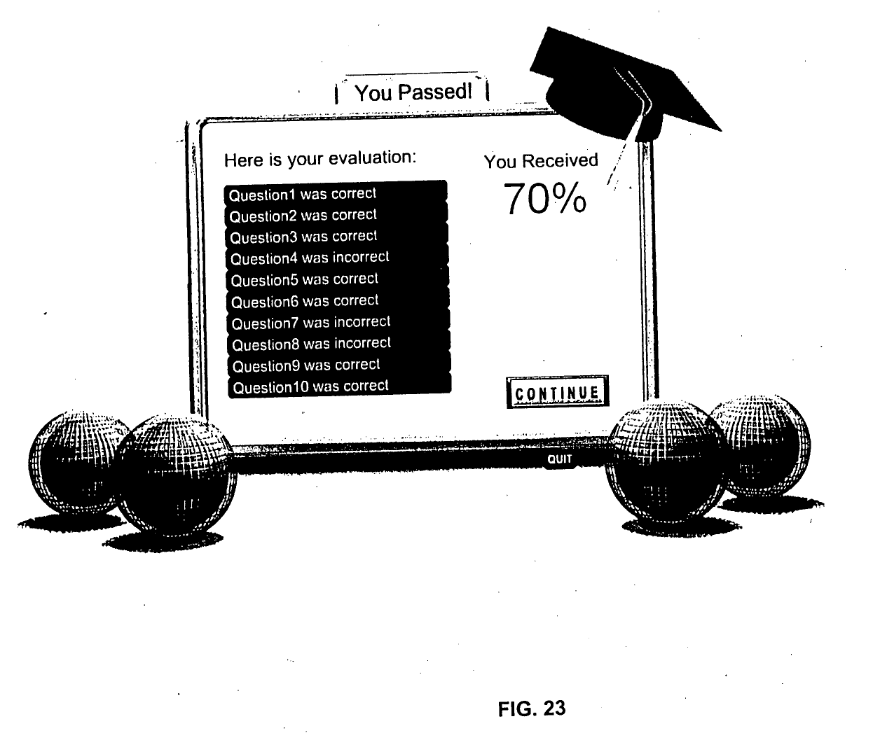

Referring to FIG. 23, there is shown a screen capture illustrating a quiz evaluation display interface (software training) screen of a training system, in accordance with a fifth embodiment of the present invention. This feature provides a student with quiz assessment and an average quiz score. This feature also includes a continue button that directs the student back to the previous exercise, if failed, or advances the student to the next exercise if he/she has passed.

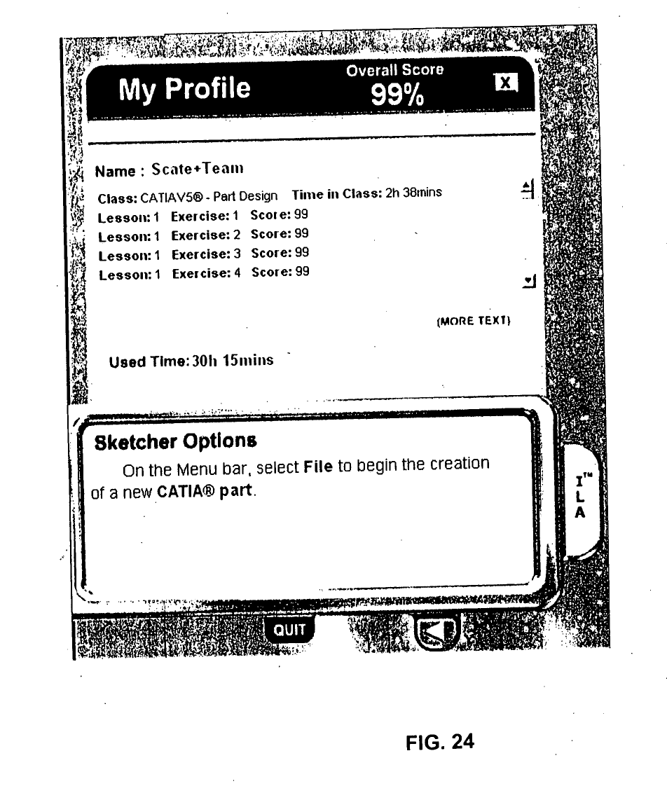

Referring to FIG. 24, there is shown a screen capture illustrating a student profile interface (software training) screen of a training system, in accordance with a fifth embodiment of the present invention. The student profile interface displays student course progress, time in class, score, and overall average.

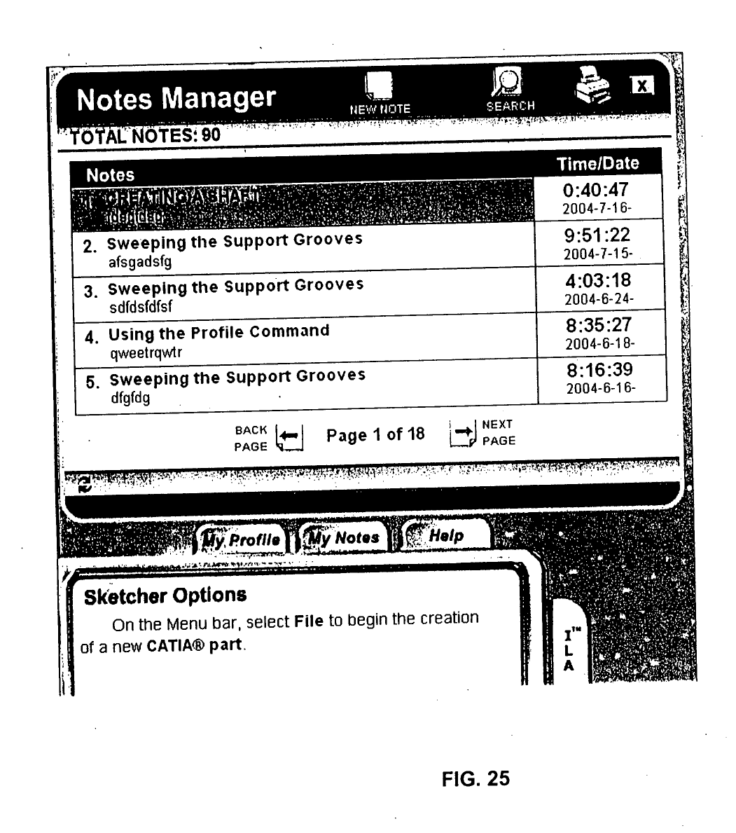

Referring to FIG. 25, there is shown a screen capture illustrating a notes manager listing interface screen of a training system, in accordance with a fifth embodiment of the present invention. This feature allows a student to create notes at any step of the course relative to a specific group, step, or subject matter. Preferably, the notes are dated and chronologically displayed.

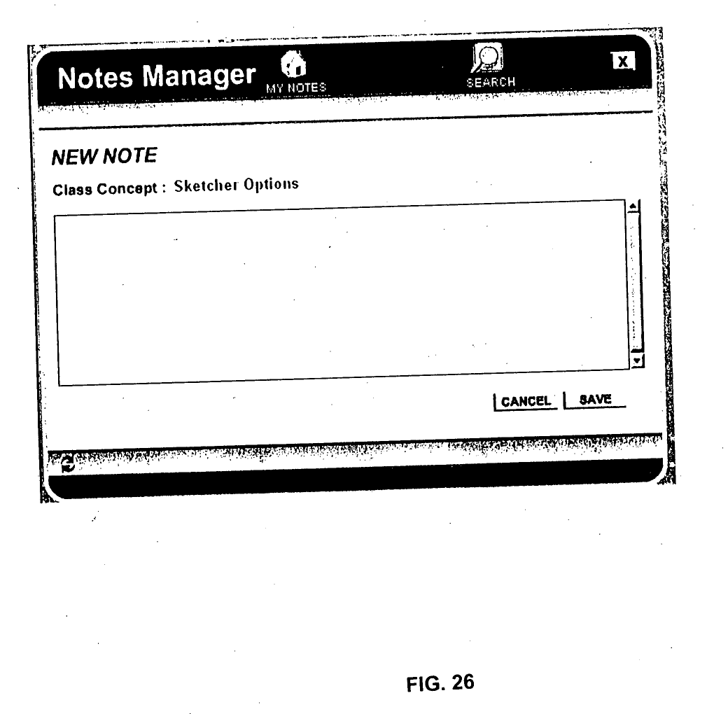

Referring to FIG. 26, there is shown a screen capture illustrating a new note creation interface screen of a training system, in accordance with a fifth embodiment of the present invention.

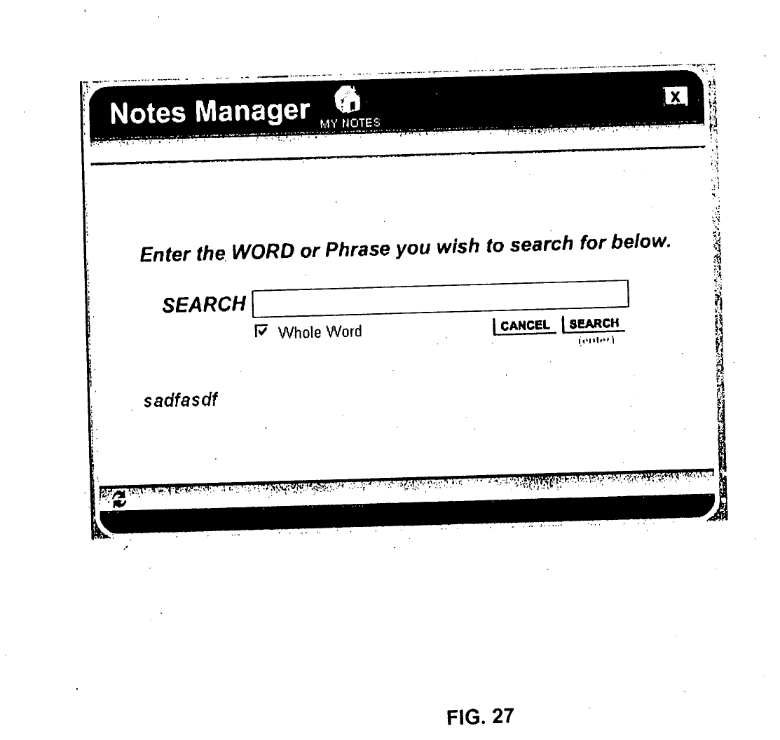

Referring to FIG. 27, there is shown a screen capture illustrating a note search interface screen of a training system, in accordance with a fifth embodiment of the present invention.

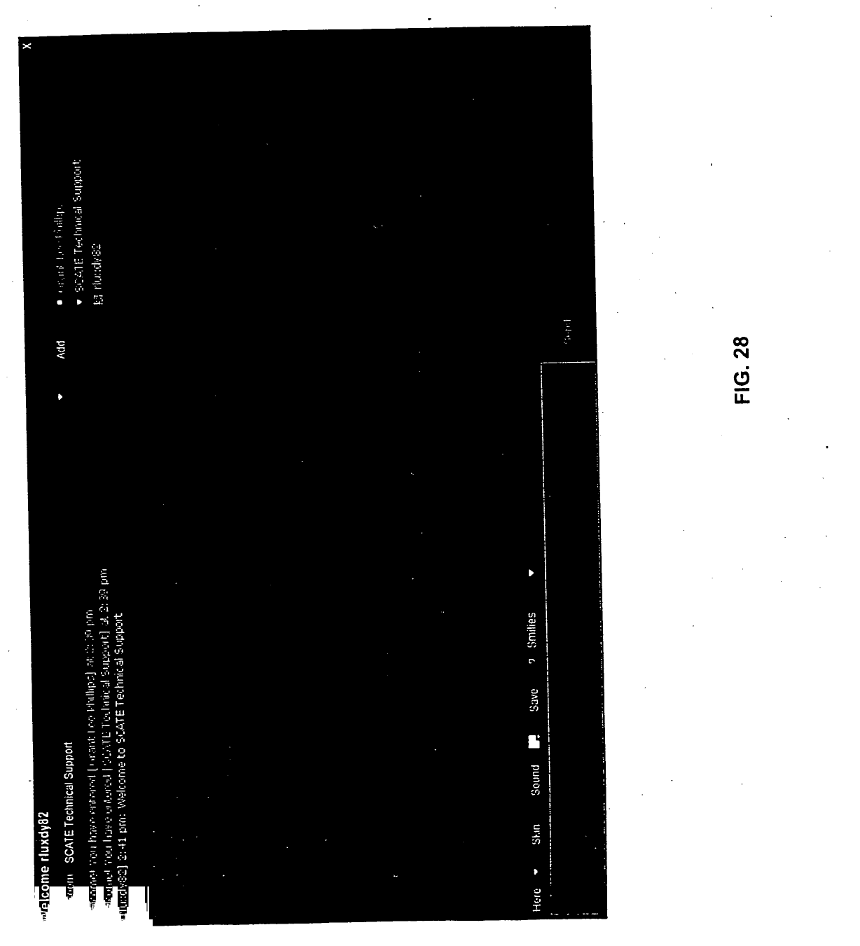

Referring to FIG. 28, there is shown a screen capture illustrating a chat, forum, and email support screen of a training system, in accordance with a fifth embodiment of the present invention.

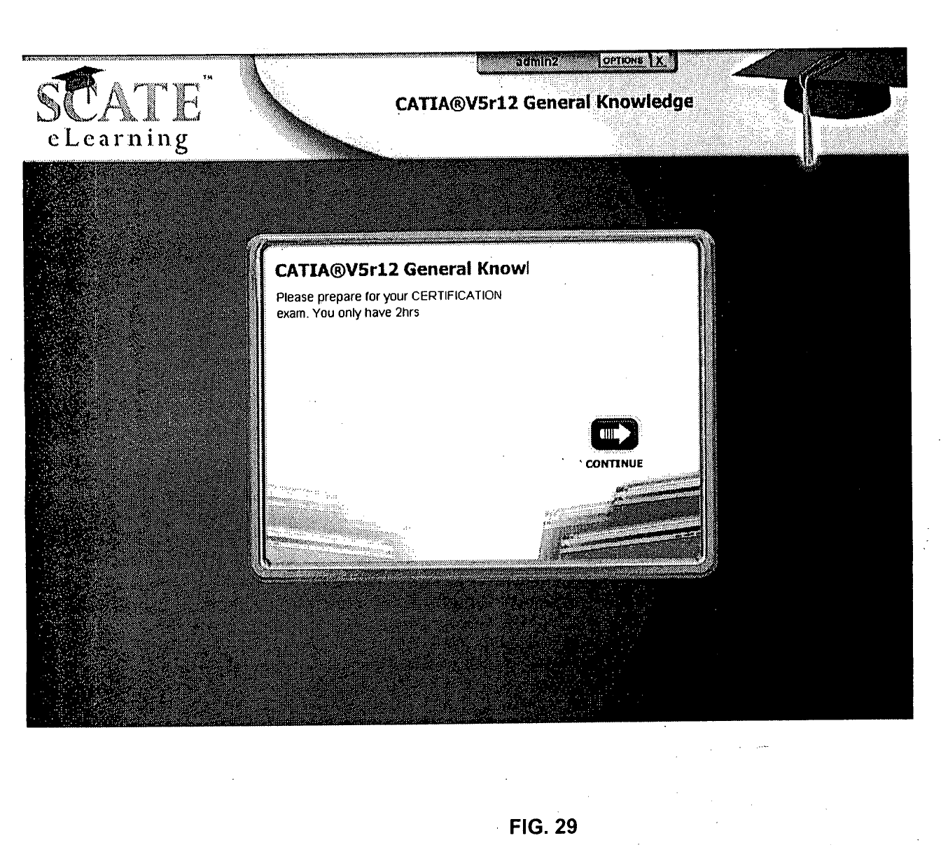

FIGS. 29-33 generally relate to the main website of the provider, with specific reference to several aspects of the certification program of the present invention.

Referring to FIG. 29, there is shown a screen capture illustrating a certification outline interface screen of a certification system, in accordance with a sixth embodiment of the present invention. This screen embodies the commencement of ILA shell feature of the present invention.

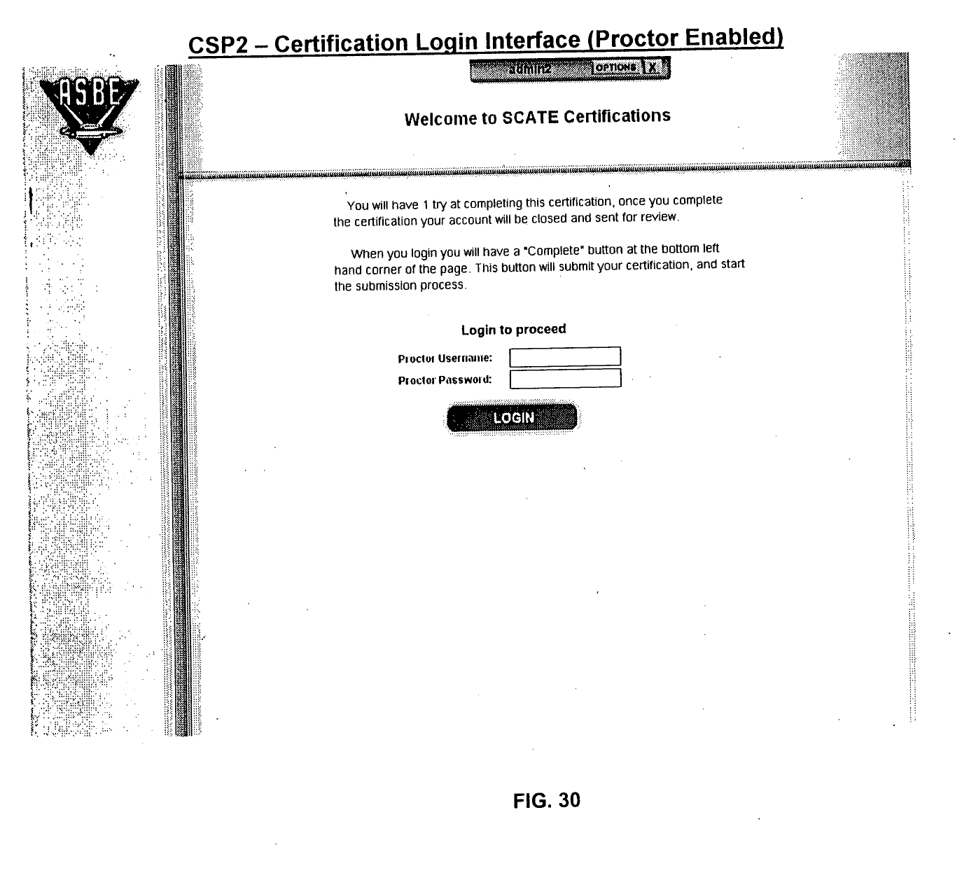

Referring to FIG. 30, there is shown a screen capture illustrating a certification login interface (proctor enabled) screen of a certification system, in accordance with a sixth embodiment of the present invention.

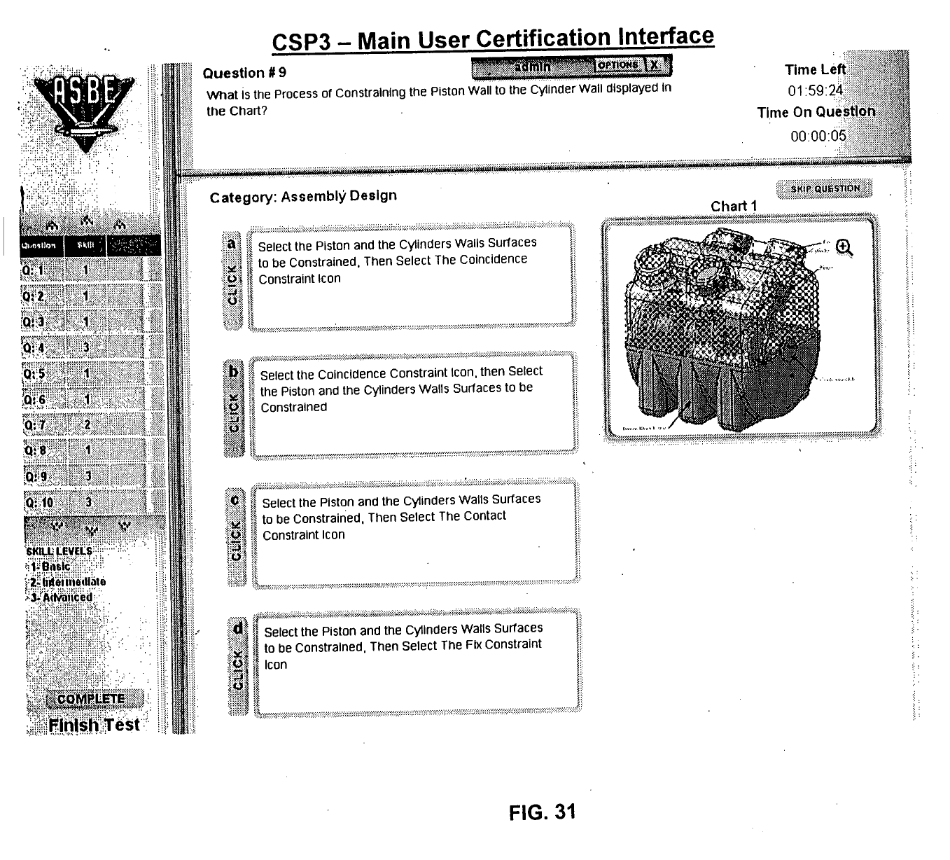

Referring to FIG. 31, there is shown a screen capture illustrating a main user certification interface screen of a certification system, in accordance with a sixth embodiment of the present invention. This screen includes questions and answers comprised of text, graphics, animation, sounds, or the like. The ILA menu system controls questions, skill levels, answers, and navigation control. This feature also controls time left in exam, time on question, and zooming functionality for the images or animation.

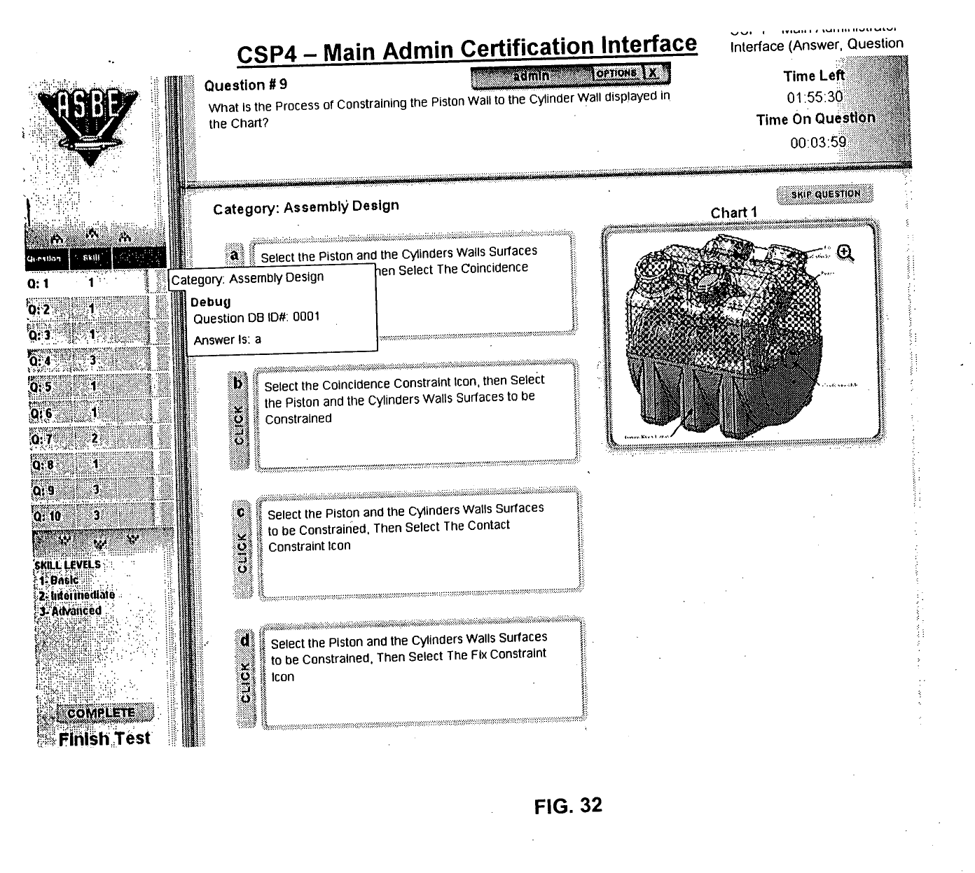

Referring to FIG. 32, there is shown a screen capture illustrating a main administration certification interface screen of a certification system, in accordance with a sixth embodiment of the present invention. This feature allows the administrator access to administrate questions and/or answers prior to randomization of the questions.

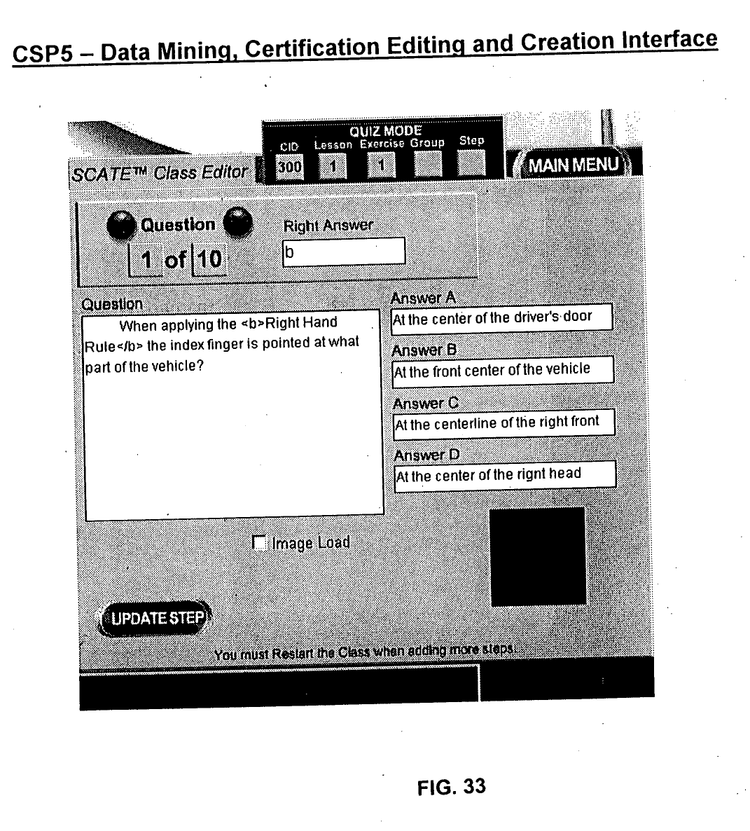

Referring to FIG. 33, there is shown a screen capture illustrating a data mining, certification editing and creation interface screen of a certification system, in accordance with a sixth embodiment of the present invention. This feature allows content providers to generate quizzes and certifications directly to the database with associated images and animation.

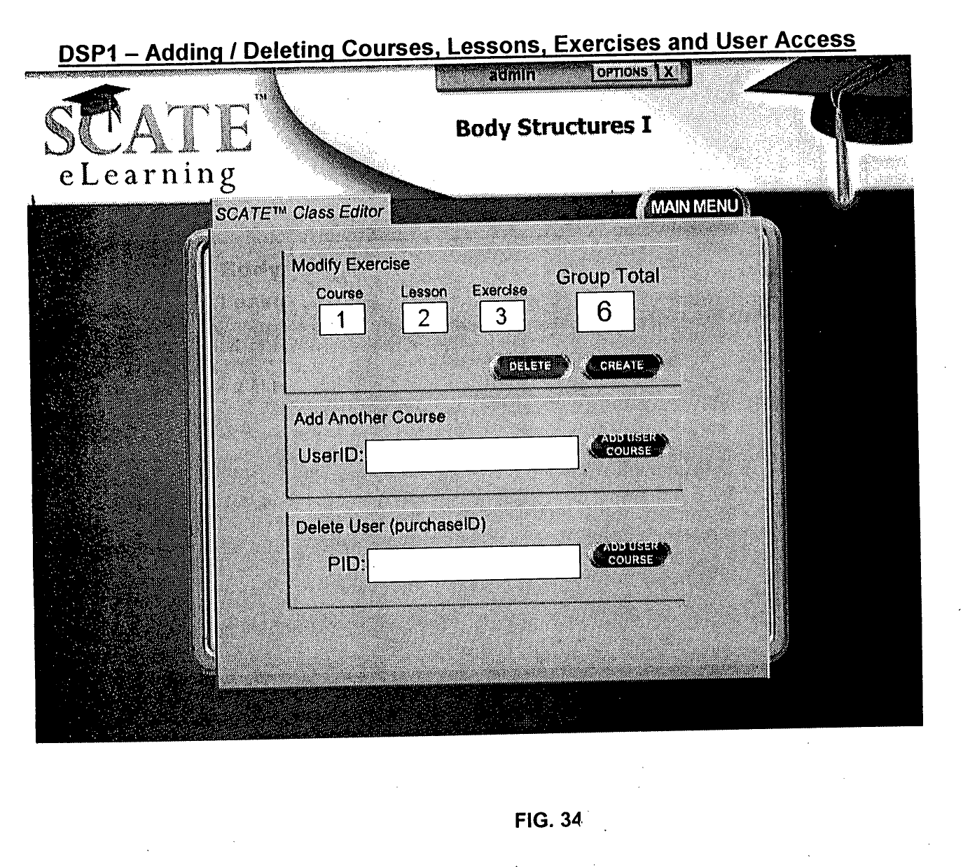

FIGS. 34-43 generally relate to the main website of the provider, with specific reference to several aspects of the courseware development system of the present invention.

Referring to FIG. 34, there is shown a screen capture illustrating an adding/deleting courses, lessons, exercises and user access interface screen of a courseware development system for a training/certification system, in accordance with a seventh embodiment of the present invention. This feature allows content providers to create and delete courses, lessons, and exercises and control the user accessibility thereof.

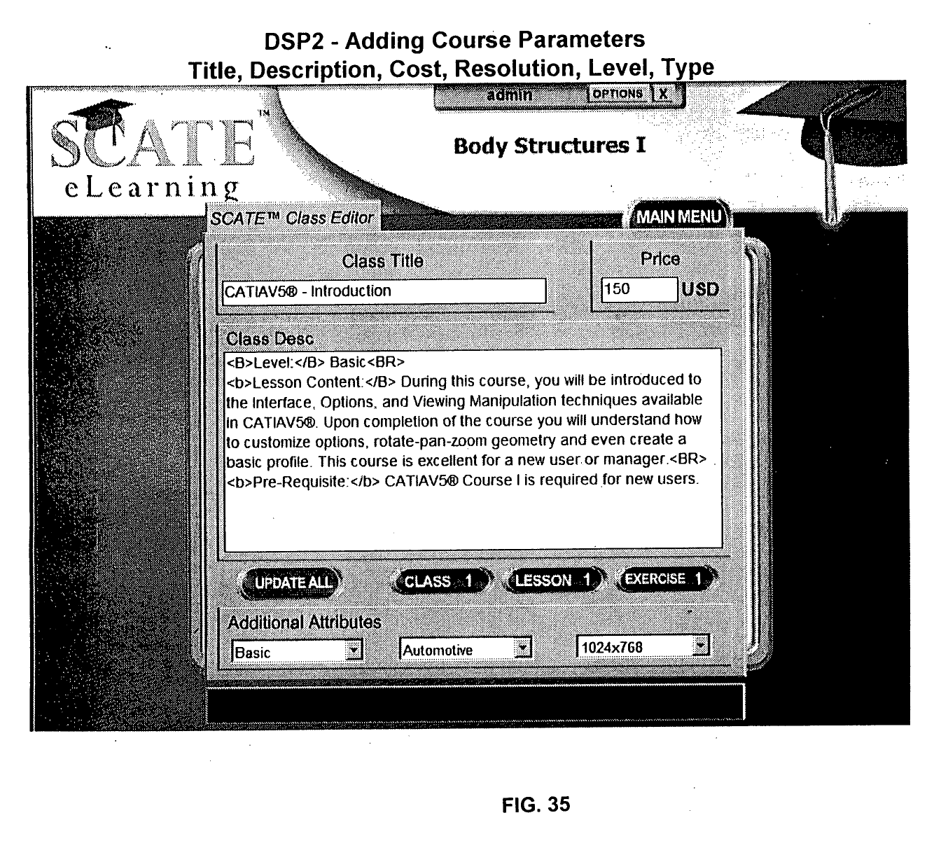

Referring to FIG. 35, there is shown a screen capture illustrating an adding course parameters interface screen of a courseware development system for a training/certification system, in accordance with a seventh embodiment of the present invention. This feature allows the content providers to define or modify course parameters such as title, description, cost, screen resolution, education level, or industry type.

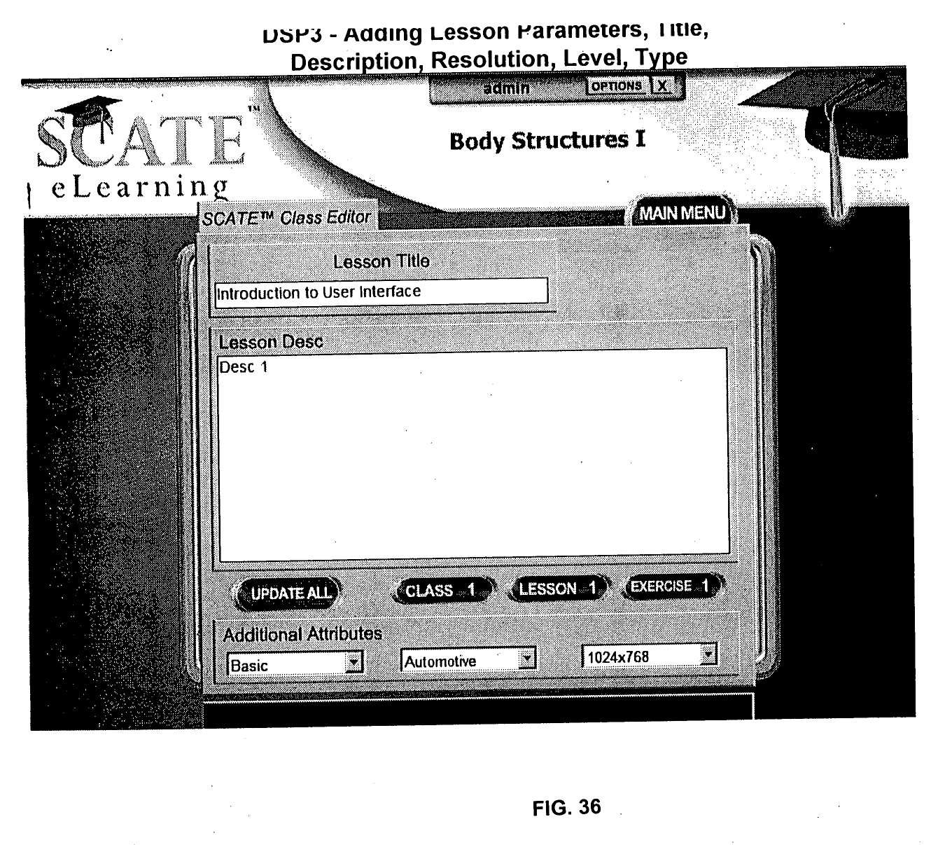

Referring to FIG. 36, there is shown a screen capture illustrating an adding lesson parameters interface screen of a courseware development system for a training/certification system, in accordance with a seventh embodiment of the present invention. This feature allows the content providers to define or modify lesson parameters such as title, description, cost, screen resolution, education level, or industry type.

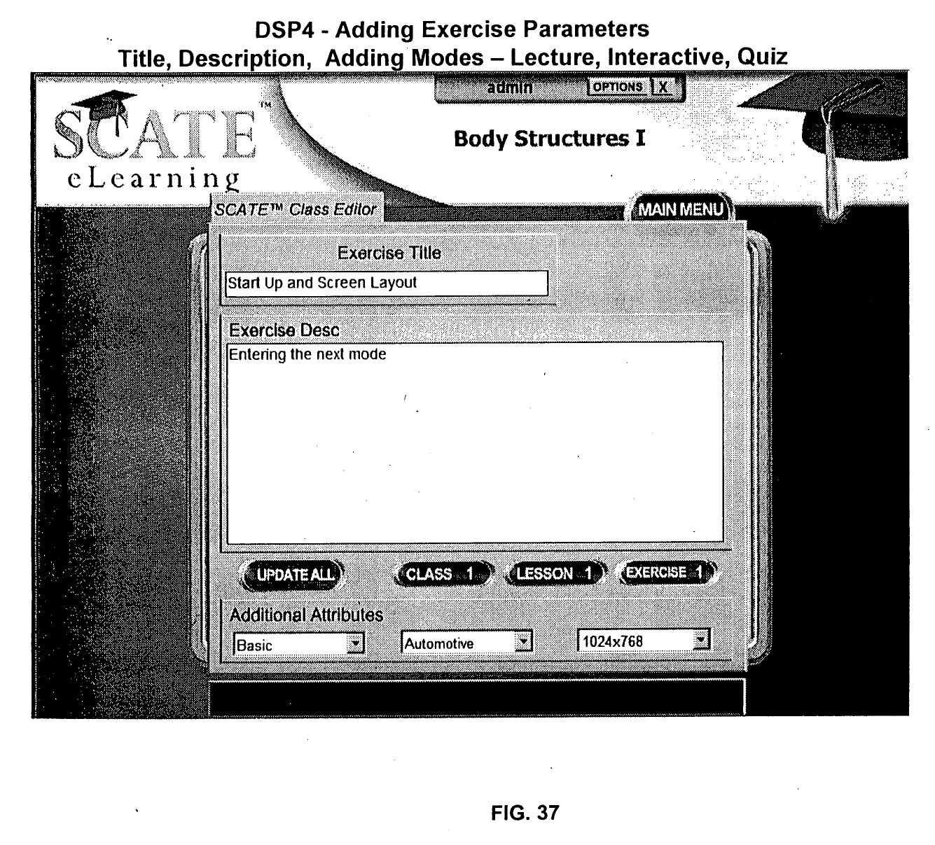

Referring to FIG. 37, there is shown a screen capture illustrating an adding exercise parameters interface screen of a courseware development system for a training/certification system, in accordance with a seventh embodiment of the present invention. This feature allows the content providers to define or modify exercise parameters such as title, description, cost, screen resolution, education level, or industry type.

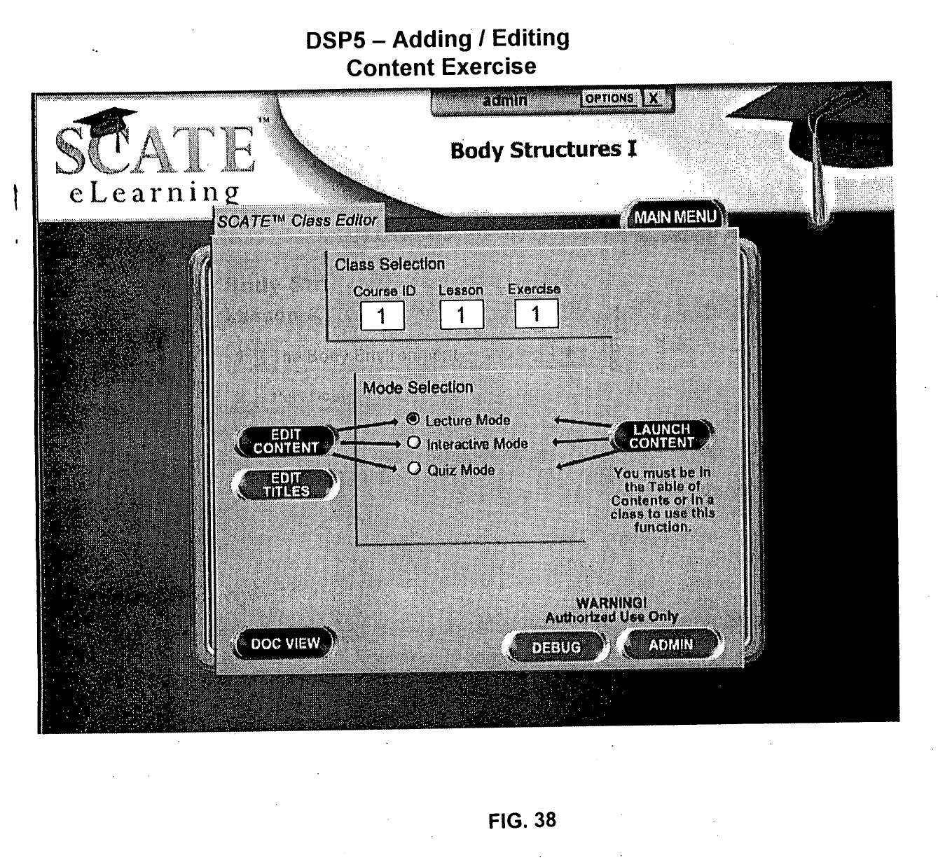

Referring to FIG. 38, there is shown a screen capture illustrating an adding/editing content exercise interface screen of a courseware development system for a training/certification system, in accordance with a seventh embodiment of the present invention. This feature allows the content providers to add, edit or launch exercise content for any mode selection such as lecture, interactive or quiz.

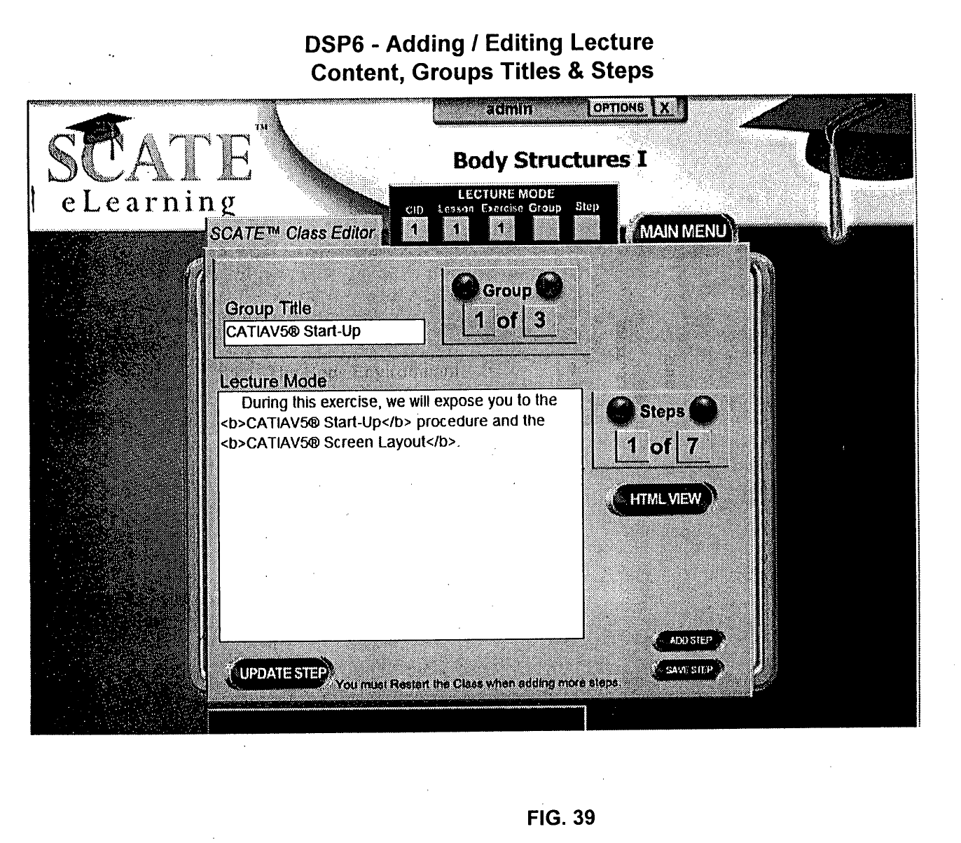

Referring to FIG. 39, there is shown a screen capture illustrating an adding/editing lecture content interface screen of a courseware development system for a training/certification system, in accordance with a seventh embodiment of the present invention. This feature allows the content providers to add or edit lecture content including group titles and steps. This content can be entered or viewed in plain text or HTML format.

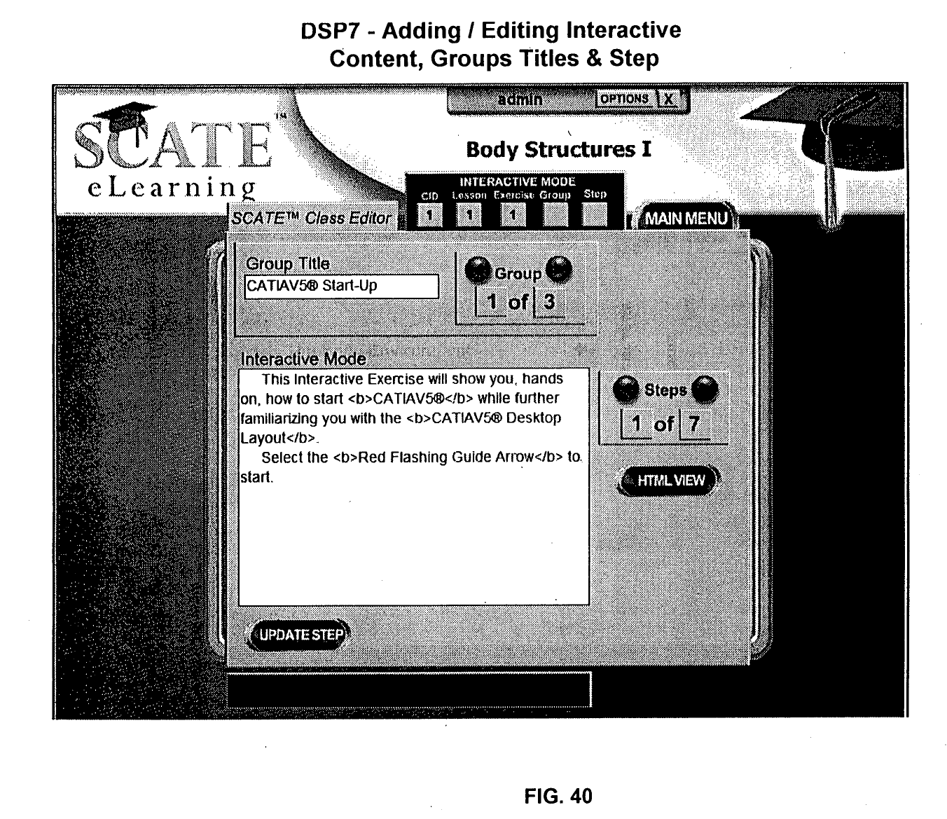

Referring to FIG. 40, there is shown a screen capture illustrating an adding/editing interactive content interface screen of a courseware development system for a training/certification system, in accordance with a seventh embodiment of the present invention. This feature allows the content providers to add or edit interactive content including group titles and steps. This content can be entered or viewed in plain text or HTML format.

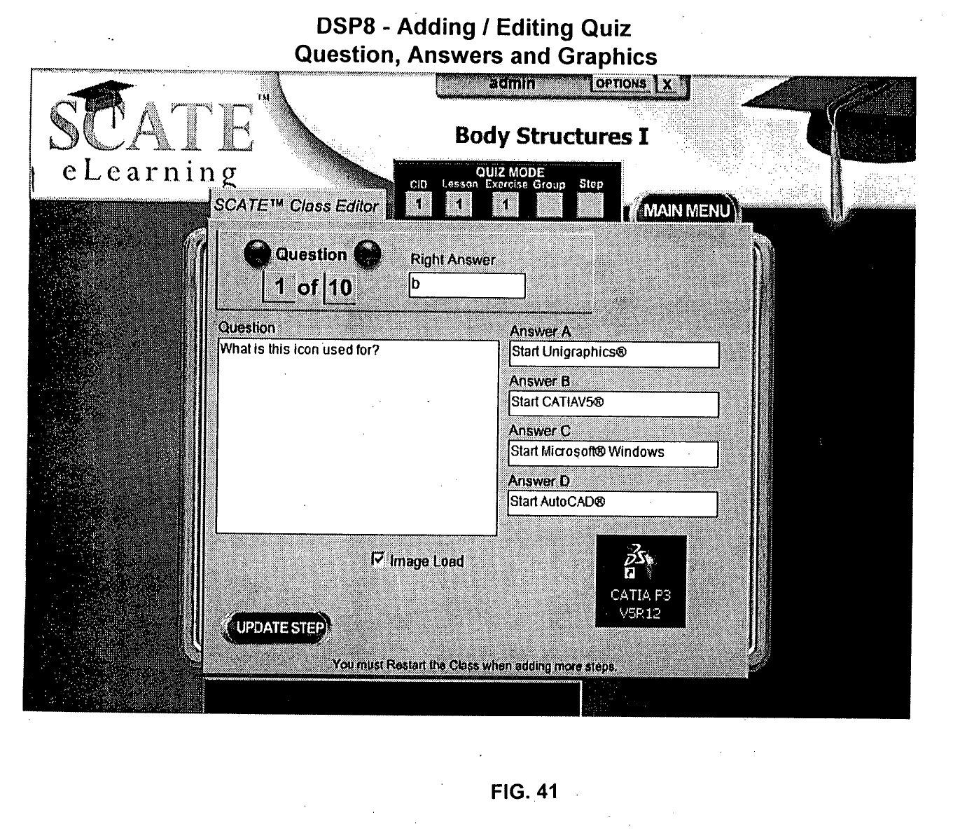

Referring to FIG. 41, there is shown a screen capture illustrating an adding/editing quiz questions interface screen of a courseware development system for a training/certification system, in accordance with a seventh embodiment of the present invention. This feature allows the content providers to add or edit quiz content including group titles and steps. This content can be entered or viewed in plain text or HTML format.

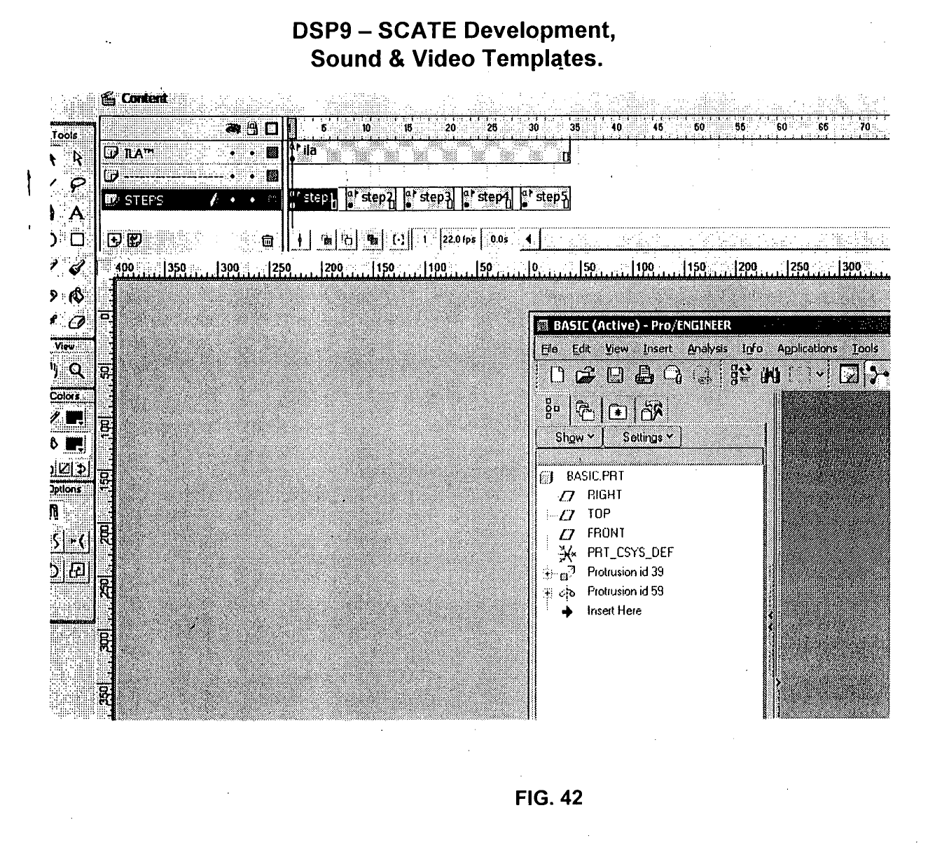

Referring to FIG. 42, there is shown a screen capture illustrating a sound and video interface screen of a courseware development system for a training/certification system, in accordance with a seventh embodiment of the present invention. This feature allows the content providers to develop multimedia courses using courseware development templates.

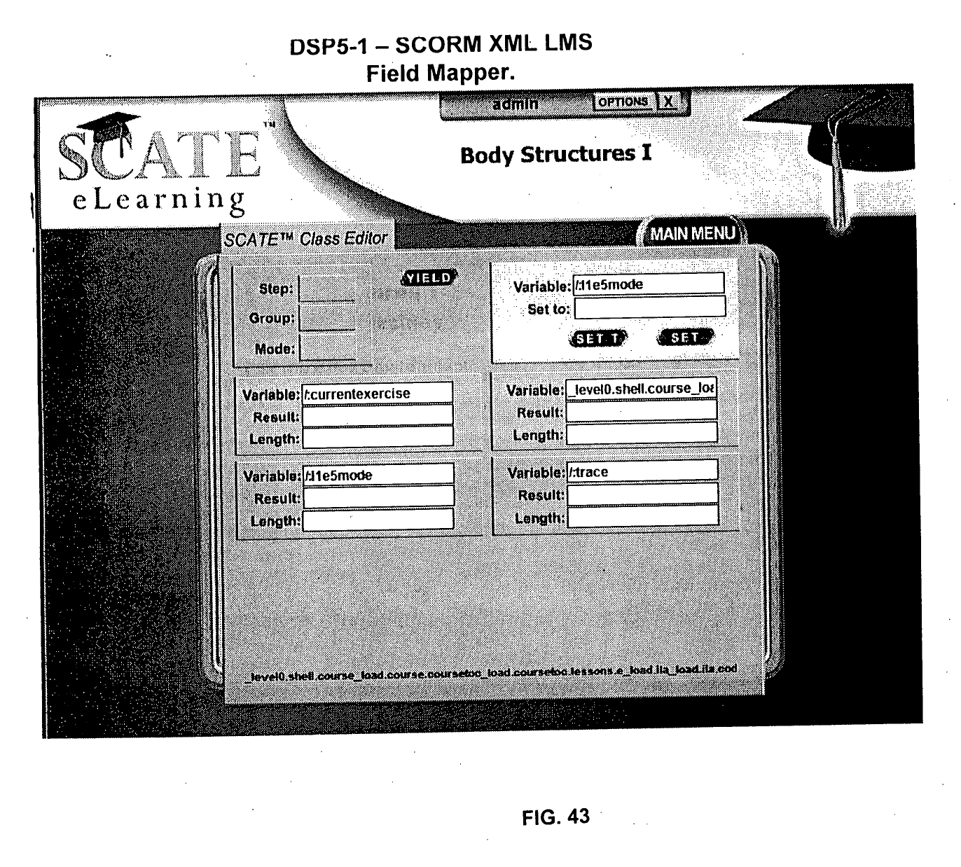

Referring to FIG. 43, there is shown a screen capture illustrating an field mapping interface screen of a courseware development system for a training/certification system, in accordance with a seventh embodiment of the present invention. This feature allows the system administrators or content providers the ability to map data between the present invention and other data containment systems.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

1. A computerized guided training program, comprising:
a source of subject matter;
a subject matter delivery system operable to deliver the subject matter to a user; and
an interactive training system in operable association with the delivery system, wherein the interactive training system comprises multiple modes of subject matter presentation, wherein the modes are selectively chosen from the group consisting of lectures, exercises, examinations, and combinations thereof.

2. The invention according to claim 1, wherein the source of subject matter is selected from the group consisting of a database, an electronic database, a data containment system, and combinations thereof.

3. The invention according to claim 1, wherein the source of subject matter comprises data selected from the group consisting of video files, audio files, animation files, database files, graphics files, text files, tabular files, and combinations thereof.

4. The invention according to claim 1, wherein the subject matter delivery system is selected from the group consisting of a computer server, a computer network, a data storage device, an optical medium, and combinations thereof.

5. The invention according to claim 1, wherein the subject matter delivery system is selected from the group consisting of transmission of the subject matter across a wide area network, transmission of the subject matter across a local area network, transmission of the subject matter from one data storage device to a second data storage device, wireless transmission of the subject matter, and combinations thereof.

6. The invention according to claim 1, wherein the presentation of multiple modes of subject matter presentation is selected from the group consisting of text, video, audio, graphics, animation, and combinations thereof.

7. The invention according to claim 1, wherein the interactive training system further comprises a user status information system.

8. The invention according to claim 7, wherein the user status information system is operable to provide information about the user selected from the group consisting of account information, demographic information, financial information, academic information, and combinations thereof.

9. A computerized guided training program, comprising:
a source of subject matter, wherein the source of subject matter comprises data selected from the group consisting of video files, audio files, animation files, database files, graphics files, text files, tabular files, and combinations thereof;
a subject matter delivery system operable to deliver the subject matter to a user; and
an interactive training system in operable association with the delivery system, wherein the interactive training system comprises multiple modes of subject matter presentation, wherein the modes are selectively chosen from the group consisting of lectures, exercises, examinations, and combinations thereof;
wherein the interactive training system includes a user status information system.

10. The invention according to claim 9, wherein the source of subject matter is selected from the group consisting of a database, an electronic database, a data containment system, and combinations thereof.

11. The invention according to claim 9, wherein the subject matter delivery system is selected from the group consisting of a computer server, a computer network, a data storage device, an optical medium, and combinations thereof.

12. The invention according to claim 9, wherein the subject matter delivery system is selected from the group consisting of transmission of the subject matter across a wide area network, transmission of the subject matter across a local area network, transmission of the subject matter from one data storage device to a second data storage device, wireless transmission of the subject matter, and combinations thereof.

13. The invention according to claim 9, wherein the presentation of multiple modes of subject matter presentation is selected from the group consisting of text, video, audio, graphics, animation, and combinations thereof.

14. The invention according to claim 9, wherein the user status information system is operable to provide information about the user selected from the group consisting of account information, demographic information, financial information, academic information, and combinations thereof.

15. A computerized guided training program, comprising:
a source of subject matter, wherein the source of subject matter comprises data selected from the group consisting of video files, audio files, animation files, database files, graphics files, text files, tabular files, and combinations thereof;
a subject matter delivery system operable to deliver the subject matter to a user; and
an interactive training system in operable association with the delivery system, wherein the interactive training system comprises multiple modes of subject matter presentation, wherein the modes are selectively chosen from the group consisting of lectures, exercises, examinations, and combinations thereof;
wherein the interactive training system includes a user status information system, wherein the user status information system is operable to provide information about the user selected from the group consisting of account information, demographic information, financial information, academic information, and combinations thereof.

16. The invention according to claim 15, wherein the source of subject matter is selected from the group consisting of a database, an electronic database, a data containment system, and combinations thereof.

17. The invention according to claim 15, wherein the subject matter delivery system is selected from the group consisting of a computer server, a computer network, a data storage device, an optical medium, and combinations thereof.

18. The invention according to claim 15, wherein the subject matter delivery system is selected from the group consisting of transmission of the subject matter across a wide area network, transmission of the subject matter across a local area network, transmission of the subject matter from one data storage device to a second data storage device, wireless transmission of the subject matter, and combinations thereof.

19. The invention according to claim 15, wherein the presentation of multiple modes of subject matter presentation is selected from the group consisting of text, video, audio, graphics, animation, and combinations thereof.

20. A computerized guided certification program, comprising:
a source of subject matter;
a subject matter delivery system operable to deliver the subject matter to a user; and
an interactive certification system in operable association with the delivery system, wherein the interactive certification system comprises multiple modes of subject matter presentation.

21. The invention according to claim 20, wherein the modes are selectively chosen from the group consisting of lectures, exercises, examinations, and combinations thereof.

22. The invention according to claim 20, wherein the source of subject matter is selected from the group consisting of a database, an electronic database, a data containment system, and combinations thereof.

23. The invention according to claim 20, wherein the source of subject matter comprises data selected from the group consisting of video files, audio files, animation files, database files, graphics files, text files, tabular files, and combinations thereof.

24. The invention according to claim 20, wherein the subject matter delivery system is selected from the group consisting of a computer server, a computer network, a data storage device, an optical medium, and combinations thereof.

25. The invention according to claim 20, wherein the subject matter delivery system is selected from the group consisting of transmission of the subject matter across a wide area network, transmission of the subject matter across a local area network, transmission of the subject matter from one data storage device to a second data storage device, wireless transmission of the subject matter, and combinations thereof.

26. The invention according to claim 20, wherein the presentation of multiple modes of subject matter presentation is selected from the group consisting of text, video, audio, graphics, animation, and combinations thereof.

27. The invention according to claim 20, wherein the interactive certification system further comprises a user status information system.

28. The invention according to claim 27, wherein the user status information system is operable to provide information about the user selected from the group consisting of account information, demographic information, financial information, academic information, and combinations thereof.

29. The invention according to claim 20, wherein the interactive certification system further comprises a randomization system for randomizing the presentation of the subject matter.

30. The invention according to claim 20, wherein the interactive certification system further comprises a certification authorization system.

31. A computerized guided certification program, comprising:
a source of subject matter;
a subject matter delivery system operable to deliver the subject matter to a user; and
an interactive certification system in operable association with the delivery system, wherein the interactive certification system comprises multiple modes of subject matter presentation;
wherein the interactive certification system includes a randomization system for randomizing the presentation of the subject matter.

32. The invention according to claim 31, wherein the modes are selectively chosen from the group consisting of lectures, exercises, examinations, and combinations thereof.

33. The invention according to claim 31, wherein the source of subject matter is selected from the group consisting of a database, an electronic database, a data containment system, and combinations thereof.

34. The invention according to claim 31, wherein the source of subject matter comprises data selected from the group consisting of video files, audio files, animation files, database files, graphics files, text files, tabular files, and combinations thereof.

35. The invention according to claim 31, wherein the subject matter delivery system is selected from the group consisting of a computer server, a computer network, a data storage device, an optical medium, and combinations thereof.

36. The invention according to claim 31, wherein the subject matter delivery system is selected from the group consisting of transmission of the subject matter across a wide area network, transmission of the subject matter across a local area network, transmission of the subject matter from one data storage device to a second data storage device, wireless transmission of the subject matter, and combinations thereof.

37. The invention according to claim 31, wherein the presentation of multiple modes of subject matter presentation is selected from the group consisting of text, video, audio, graphics, animation, and combinations thereof.

38. The invention according to claim 31, wherein the interactive certification system further comprises a user status information system.

39. The invention according to claim 38, wherein the user status information system is operable to provide information about the user selected from the group consisting of account information, demographic information, financial information, academic information, and combinations thereof.

40. The invention according to claim 31, wherein the interactive certification system further comprises a certification authorization system.

41. A computerized guided certification program, comprising:
a source of subject matter;
a subject matter delivery system operable to deliver the subject matter to a user; and
an interactive certification system in operable association with the delivery system, wherein the interactive certification system comprises multiple modes of subject matter presentation;
wherein the interactive certification system includes a randomization system for randomizing the presentation of the subject matter;
wherein the interactive certification system includes a certification authorization system.

42. The invention according to claim 41, wherein the modes are selectively chosen from the group consisting of lectures, exercises, examinations, and combinations thereof.

43. The invention according to claim 41, wherein the source of subject matter is selected from the group consisting of a database, an electronic database, a data containment system, and combinations thereof.

44. The invention according to claim 41, wherein the source of subject matter comprises data selected from the group consisting of video files, audio files, animation files, database files, graphics files, text files, tabular files, and combinations thereof.

45. The invention according to claim 41, wherein the subject matter delivery system is selected from the group consisting of a computer server, a computer network, a data storage device, an optical medium, and combinations thereof.

46. The invention according to claim 41, wherein the subject matter delivery system is selected from the group consisting of transmission of the subject matter across a wide area network, transmission of the subject matter across a local area network, transmission of the subject matter from one data storage device to a second data storage device, wireless transmission of the subject matter, and combinations thereof.

47. The invention according to claim 41, wherein the presentation of multiple modes of subject matter presentation is selected from the group consisting of text, video, audio, graphics, animation, and combinations thereof.

48. The invention according to claim 41, wherein the interactive certification system further comprises a user status information system.

49. The invention according to claim 48, wherein the user status information system is operable to provide information about the user selected from the group consisting of account information, demographic information, financial information, academic information, and combinations thereof.

50. A courseware development system for a computerized guided training or certification system, comprising:
a subject matter delivery system operable to deliver a source of subject matter to a user; and
a subject matter management system in operable association with the delivery system, wherein the subject matter management system is operable to dynamically create, delete, or modify subject matter.

51. The invention according to claim 50, wherein the subject matter management system is operable to modify multiple modes of subject matter presentation.

52. The invention according to claim 51, wherein the presentation of multiple modes of subject matter presentation is selected from the group consisting of text, video, audio, graphics, animation, and combinations thereof.

53. The invention according to claim 50, wherein the subject matter management system further comprises a user access control system.

54. The invention according to claim 50, wherein the source of subject matter is selected from the group consisting of a database, an electronic database, a data containment system, and combinations thereof.

55. The invention according to claim 50, wherein the source of subject matter comprises data selected from the group consisting of video files, audio files, animation files, database files, graphics files, text files, tabular files, and combinations thereof.

56. The invention according to claim 50, wherein the subject matter delivery system is selected from the group consisting of a computer server, a computer network, a data storage device, an optical medium, and combinations thereof.

57. The invention according to claim 50, wherein the subject matter delivery system is selected from the group consisting of transmission of the subject matter across a wide area network, transmission of the subject matter across a local area network, transmission of the subject matter from one data storage device to a second data storage device, wireless transmission of the subject matter, and combinations thereof.

58. The invention according to claim 50, wherein the subject matter management system further comprises a user status information system.

59. The invention according to claim 58, wherein the user status information system is operable to provide information about the user selected from the group consisting of account information, demographic information, financial information, academic information, and combinations thereof.

60. A courseware development system for a computerized guided training or certification system, comprising:
a subject matter delivery system operable to deliver a source of subject matter to a user; and
a subject matter management system in operable association with the delivery system, wherein the subject matter management system is operable to dynamically create, delete, or modify subject matter, wherein the subject matter management system is operable to modify multiple modes of subject matter presentation.

61. The invention according to claim 60, wherein the presentation of multiple modes of subject matter presentation is selected from the group consisting of text, video, audio, graphics, animation, and combinations thereof.

62. The invention according to claim 60, wherein the subject matter management system further comprises a user access control system.

63. The invention according to claim 60, wherein the source of subject matter is selected from the group consisting of a database, an electronic database, a data containment system, and combinations thereof.

64. The invention according to claim 60, wherein the source of subject matter comprises data selected from the group consisting of video files, audio files, animation files, database files, graphics files, text files, tabular files, and combinations thereof.

65. The invention according to claim 60, wherein the subject matter delivery system is selected from the group consisting of a computer server, a computer network, a data storage device, an optical medium, and combinations thereof.

66. The invention according to claim 60, wherein the subject matter delivery system is selected from the group consisting of transmission of the subject matter across a wide area network, transmission of the subject matter across a local area network, transmission of the subject matter from one data storage device to a second data storage device, wireless transmission of the subject matter, and combinations thereof.

67. The invention according to claim 60, wherein the subject matter management system further comprises a user status information system.

68. The invention according to claim 67, wherein the user status information system is operable to provide information about the user selected from the group consisting of account information, demographic information, financial information, academic information, and combinations thereof.

69. A courseware development system for a computerized guided training or certification system, comprising:
a subject matter delivery system operable to deliver a source of subject matter to a user; and
a subject matter management system in operable association with the delivery system, wherein the subject matter management system is operable to dynamically create, delete, or modify subject matter, wherein the subject matter management system is operable to modify multiple modes of subject matter presentation, wherein the subject matter management system includes a user access control system.

70. The invention according to claim 69, wherein the subject matter management system is operable to modify multiple modes of subject matter presentation.

71. The invention according to claim 69, wherein the presentation of multiple modes of subject matter presentation is selected from the group consisting of text, video, audio, graphics, animation, and combinations thereof.

72. The invention according to claim 69, wherein the source of subject matter is selected from the group consisting of a database, an electronic database, a data containment system, and combinations thereof.

73. The invention according to claim 69, wherein the source of subject matter comprises data selected from the group consisting of video files, audio files, animation files, database files, graphics files, text files, tabular files, and combinations thereof.

74. The invention according to claim 69, wherein the subject matter delivery system is selected from the group consisting of a computer server, a computer network, a data storage device, an optical medium, and combinations thereof.

75. The invention according to claim 69, wherein the subject matter delivery system is selected from the group consisting of transmission of the subject matter across a wide area network, transmission of the subject matter across a local area network, transmission of the subject matter from one data storage device to a second data storage device, wireless transmission of the subject matter, and combinations thereof.

76. The invention according to claim 69, wherein the subject matter management system further comprises a user status information system.

77. The invention according to claim 76, wherein the user status information system is operable to provide information about the user selected from the group consisting of account information, demographic information, financial information, academic information, and combinations thereof.
